(19) United States
(12) Patent Application Publication
(10) Pub. No.: US 2015/0018493 A1
(43) Pub. Date: Jan. 15, 2015

(54) SALEN INDIUM CATALYSTS AND METHODS OF MANUFACTURE AND USE THEREOF

(71) Applicants: GREENCENTRE CANADA, Kingston (CA); THE UNIVERSITY OF BRITISH COLUMBIA, Vancouver (CA)

(72) Inventors: Parisa Mehrkhodavandi, Vancouver (CA); Dinesh C. Aluthge, Vancouver (CA); Timothy James Clark, Kingston (CA); Brian Mariampillai, Kingston (CA); Yun Yang, Kingston (CA)

(73) Assignee: GREENCENTRE CANADA, Kingston (CA)

(21) Appl. No.: 14/384,839

(22) PCT Filed: Mar. 13, 2013
(86) PCT No.: PCT/CA13/50191

§ 371 Date: Sep. 12, 2014

Related U.S. Application Data
(60) Provisional application No. 61/610,057, filed on Mar. 13, 2012.

(51) Int. Cl. C08G 63/82; C08G 63/08; C08G 63/91

(52) U.S. Cl. CPC C08G 63/823; C08G 63/912; C08G 63/08
USPC 525/411; 556/34; 528/282

(57) ABSTRACT

The present application provides salen indium catalysts of the following general structure

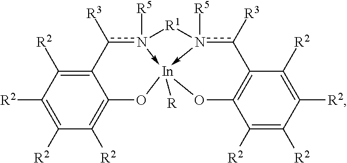

and the corresponding dimers. The salen indium catalysts are particularly useful in catalyzing ring-opening polymerizations of cyclic ester monomers, such as lactides. Also provided herein are methods of using the salen indium complexes to catalyze polymerization of cyclic ester monomers. Of particular interest is the successful polymerization of lactides using the present salen indium catalysts to produce poly(lactic acid) having high isotacticity.

### CROSS-REFERENCE

The present application claims priority to U.S. provisional patent application No. 61/610,057, filed Mar. 13, 2012, the entirety of which is incorporated herein by reference.

### FIELD OF THE INVENTION

The present invention pertains to salen indium complexes. More particularly, the present invention pertains to salen indium complexes that are useful as catalysts, for example, in ring opening polymerizations, such as stereoselective polymerization of lactide to give isotactically enriched polylactic acid.

### BACKGROUND

Poly(lactic acid), or poly(lactide), commonly referred to as PLA, is a commercially important biodegradable polyester that has many potential medical, agricultural, and packaging applications because of its biocompatibility and biodegradability. Concern about the environmental impact and increasing cost of petroleum based polymers has renewed interest in polymers derived from natural products, such as PLA.

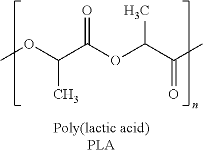

PLA is produced by the ring opening polymerization (ROP) of the six-membered cyclic ester lactide. (Dechy-Cabaret, O.; Martin-Vaca, B.; Bourissou, D. Chem. Rev. 2004, 104, 6147-6176.; Gupta, B.; Revagade, N.; Hilborn, J. Prog. Poly. Sci. 2007, 32, 455-482.; Oh, J. K. Soft Matter 2011, 7, 5096-5108.) Lactic acid (LA) is produced in chiral and racemic forms by fermentation of corn and other agricultural products. Lactides are the cyclic diesters of lactic acid and are prepared by the dehydration of lactic acid. When lactide is prepared from racemic lactic acid, the three isomers that result are R-lactide (D-lactide), S-lactide (L-lactide) and meso-lactide. rac-lactide is a 50:50 mixture of R-lactide and S-lactide.

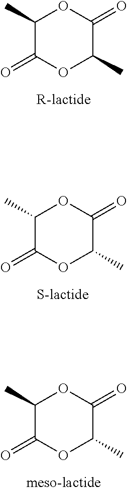

The stereochemistry of PLAs determines, at least in part, their mechanical, physical and thermal properties, as well as their rates of degradation. The bulk properties of PLAs, especially their melting points, are intrinsically linked to the polymer microstructure. Poly(R-lactic acid) and poly(S-lactic acid) are both crystalline polymers with melting points of about 180° C., while atactic PLA produced from the polymerization of RS-lactide is an amorphous polymer with no melting point. The ability to control the polymer tacticity can have an enormous impact on the properties and applications of the final polymer. (Dijkstra, P. J.; Du, H. Z.; Feijen, J. Polym. Chem. 2011, 2, 520-527; Buffet, J. C.; Okuda, J. Polym. Chem. 2011, 2, 2758-2763; Thomas, C. M. Chem. Soc. Rev. 2010, 39, 165-173; Stanford, M. J.; Dove, A. P. Chem. Soc. Rev. 2010, 39, 486-494.)

Isotactic PLA derived solely from L-lactide (Pₘ=0.8, where Pₘ is the probability of finding a pair of adjacent structural units in a polymer that have the same stereochemistry) has a melting point of 178° C., while all heterotactic polymers generated to date through chain end control are amorphous. (Buffet, J. C.; Okuda, J. Polym. Chem. 2011, 2, 2758-2763; Fukushima, K.; Kimura, Y. Polym. Int. 2006, 55, 626-642) Stereoblock polymers generated from rac-LA using selective chiral aluminum salen complexes, can have melting points of well over 200° C., displaying the power of stereoselective ROP catalysts (Fukushima, K.; Kimura, Y. Polym. Int. 2006, 55, 626-642.).

Stereoselective complexes for use in the ROP of rac-lactide are rare. Site selective systems are limited to chiral aluminum complexes for LA ROP were reported by Spassky (Spassky, N.; Wisniewski, M.; Pluta, C.; LeBorgne, A. Macromol. Chem. Phys. 1996, 197, 2627-2637) Coates (Ovitt, T. M.; Coates, G. W. J. Am. Chem. Soc. 1999, 121, 4072-4073; Ovitt, T. M.; Coates, G. W. J. Polym. Sci. Pol. Chem. 2000, 38, 4686-4692; Ovitt, T. M.; Coates, G. W. J. Am. Chem. Soc. 2002, 124, 1316-1326), Smith, (Radano, C. P.; Baker, G. L.; Smith, M. R. J. Am. Chem. Soc. 2000, 122, 1552-1553) and Feijen (Pₘ>0.9) (Zhong, Z. Y.; Dijkstra, P. J.; Feijen, J. Angew. Chem. Int. Ed. 2002, 41, 4510-4513; Zhong, Z. Y.; Dijkstra, P. J.; Feijen, J. J. Am. Chem. Soc. 2003, 125, 11291-11298).

The aluminum systems bear Schiff base ligands with a chiral auxiliary and preferentially polymerize either R- or S-LA, depending on the stereochemistry of the auxiliary, to form isotactic or stereoblock PLA. Complimentary achiral aluminum complexes reported by Chen (Tang, Z. H.; Chen, X. S.; Pang, X.; Yang, Y. K.; Zhang, X. F.; Jing, X. B. Biomacromolecules 2004, 5, 965-970; Tang, Z. H.; Chen, X. S.; Yang, Y. K.; Pang, X.; Sun, J. R.; Zhang, X. F.; Jing, X. B. J. Polym. Sci. Pol. Chem. 2004, 42, 5974-5982), Nomura (Nomura, N.; Ishii, R.; Akakura, M.; Aoi, K. J. Am. Chem. Soc. 2002, 124, 5938-5939; Ishii, R.; Nomura, N.; Kondo, T. Polym. J. 2004, 36, 261-264; Nomura, N.; Ishii, R.; Yamamoto, Y.; Kondo, T. Chem. Eur. J. 2007, 13, 4433-4451; Nomura, N.; Akita, A.; Ishii, R.; Mizuno, M. J. Am. Chem. Soc. 2010, 132, 1750-1751) and Gibson (Hormnirun, P.; Marshall, E. L., Gibson, V. C., White, A. J. P., Williams, D. J. J. Am. Chem. Soc. 2004, 126, 2688-2689; Hormnirun, P., Marshall, E. L., Gibson, V. C., Pugh, R. I., White, A. J. P. PNAS 2006, 103, 15343-15348) generate isotactic PLA via chain end control (0.7<Pₘ<0.9).

Chisholm has illustrated some of the complexities in stereocontrol with these systems. (Chisholm, M. H.; Patmore, N. J.; Zhou, Z. P. Chem. Commun. 2005, 127-129; Chisholm, M. H.; Gallucci, J. C.; Quisenberry, K. T.; Zhou, Z. P. Inorg. Chem. 2008, 47, 2613-2624) Organocatalysts reported by Henrick and Waymouth also produce isotactic PLA (Pₘ up to 0.9) at −70° C. (Dove, A. P.; Li, H. B.; Pratt, R. C.; Lohmeijer, B. G. G.; Culkin, D. A.; Waymouth, R. M.; Hedrick, J. L. Chem. Commun. 2006, 2881-2883; Zhang, L.; Nederberg, F.; Pratt, R. C.; Waymouth, R. M.; Hedrick, J. L.; Wade, C. G. Macromolecules 2007, 40, 4154-4158).

More recently other modestly stereoselective (Pₘ<0.7) catalysts have been reported by Douglas (Douglas, A. F.; Patrick, B. O.; Mehrkhodavandi, P. Angew. Chem. Int. Ed. 2008, 47, 2290-2293) as well as Otero and Sanchez (Otero, A.; Fernandez-Baeza, J.; Lara-Sanchez, A.; Alonso-Moreno, C.; Marquez-Segovia, I.; Sanchez-Barba, L. F.; Rodriguez, A. M. Angew. Chem. Int. Ed. 2009, 48, 2176-2179), Arnold (Buffet, J.-C.; Okuda, J.; Arnold, P. L. Inorg. Chem. 2010, 49, 419-426), Schaper (Drouin, F.; Whitehorne, T. J. J.; Schaper, F. Dalton Trans. 2011, 40, 1396-1400, and Normand (Kirillov, E; Roisnel, T; Carpentier, J-F. Catalysis and Organometallics, 2012, 31(4), 1448-1457).

Chiral catalysts can be used to selectively polymerize one stereoisomer in a racemic mixture of lactides to produce isotactically enriched PLA. For example, metal-salen complexes have been widely used in asymmetric catalysis including stereoselective polymerization of rac-lactide. (Canali, L.; Sherrington, D. C. Chem. Soc. Rev. 1999, 28, 85; Dechy-Cabaret, O.; Martin-Vaca, B.; Bourissou, D. Chem. Rev. 2004, 104, 6147.) Salen-aluminum complexes in particular have been found to have utility at stereoselectively catalyzing the synthesis of (Poly)lactic acid or PLA. (Ovitt, T. M.; Coates, G. W. J. Am. Chem. Soc. 2002, 124, 1316; Zhong, Z.; Dijkstra, P. J.; Feijen, J. Angew. Chem. Int. Ed. 2002, 41, 4510.)

Although the site selective chiral aluminum complexes discussed above are by far the most successful systems in generating isotactic PLA, they suffer from low reactivity and often require several hours at elevated temperatures to achieve high conversions. Recently, a highly active indium catalyst was disclosed for the polymerization of lactide with moderate selectivity. (Douglas, A. F.; Patrick, B. O.; Mehrkhodavandi, P. Angew. Chem., Int. Ed. 2008, 47, 2290.) Accordingly, there remains a need for alternative catalysts that are stereoselective for the ring opening polymerization (ROP) of lactide.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a salen indium catalyst and methods of manufacture and use thereof. These catalysts are useful in catalyzing ring opening polymerizations, such as, the polymerization of lactide. Specifically, it has now been found that indium complexes bearing a salen ligand show an unprecedented combination of site-selectivity and activity for the ring opening polymerization of lactide.

In accordance with one aspect, there is provided a complex having the structure of formula (Ia) or the corresponding dimer of formula (Ib):

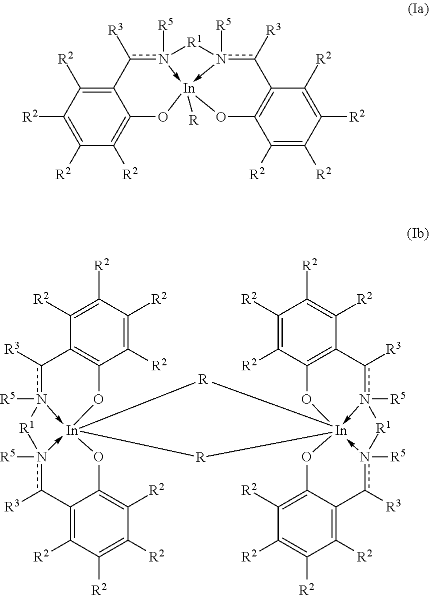

wherein
the dashed line represents an optional double bond;
R¹ is an optionally substituted C₂₋₅ alkylene,

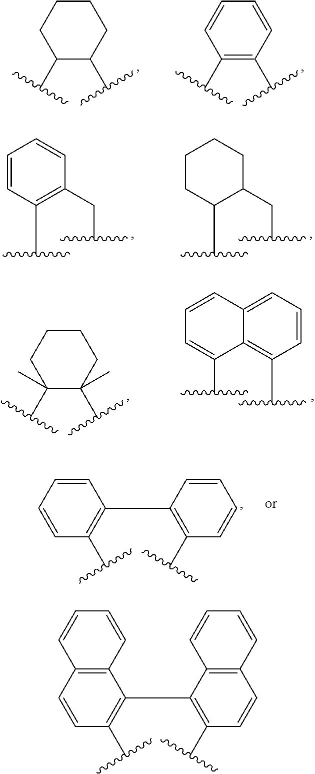

each R² is independently hydrogen, halogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl), optionally substituted phenyl or SiR′, where R′ is alkyl or aryl;
each R³ is hydrogen or optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl);
each R is independently OR⁴, NR⁴₂ or SR⁴; and CH₂SiR⁴₃, where R⁴ is hydrogen, optionally substituted linear or branched C₁₋₁₈ alkyl (e.g., C₁₋₅ alkyl), such as a fluoro-substituted alkyl, or optionally substituted linear or branched (C₁₋₁₂)alkylcarbonyl (e.g., (C₁₋₅)alkylcarbonyl), such as C(O)CH₂OCH₃; and
each R⁵ is independently hydrogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl) or, when there is a C—N double bond, absent.

In accordance with one embodiment, the complex is

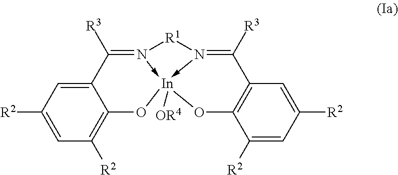

, or the corresponding dimer.

In accordance with one embodiment, R¹ is

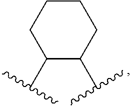 [SMILES: *C1CCCCC1*]

each R² is C₁₋₅ alkyl, R³ is H and R⁴ is C₁₋₃ alkyl.

In accordance with one embodiment, R¹ is chiral. In accordance with an alternative embodiment, the stereochemistry of R¹ is (R,R).

In accordance with one embodiment, the complex has the structure

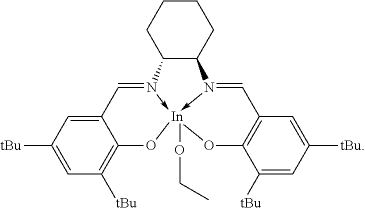

In accordance with another aspect, there is provided a method of making poly(lactic acid) comprising polymerizing lactide in the presence of a complex having the structure of formula (Ia) or its corresponding dimer or formula (Ib):

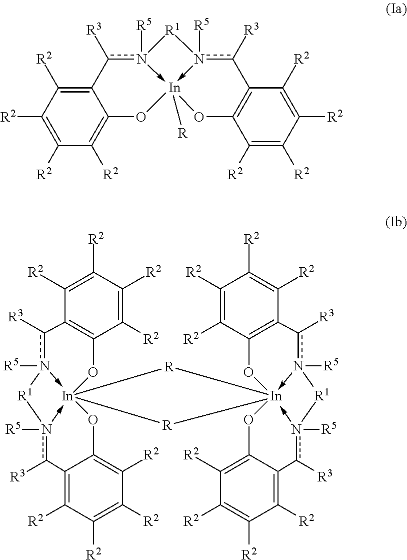

wherein
the dashed line represents an optional double bond;
R¹ is an optionally substituted C₂₋₅ alkylene,

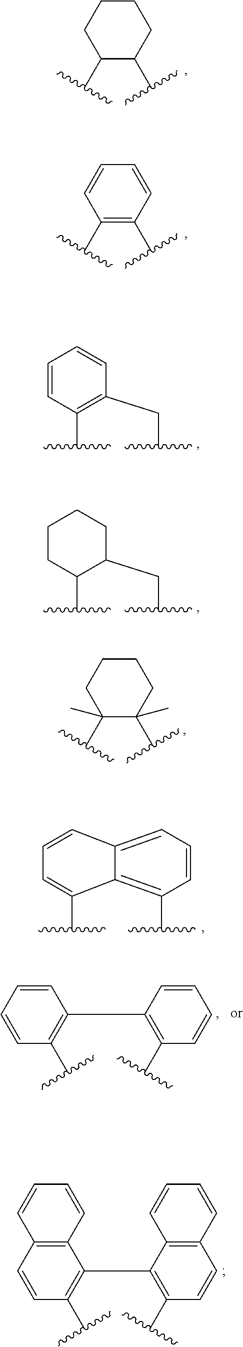

each R² is independently hydrogen, halogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl), optionally substituted phenyl or SiR′, where R′ is alkyl or aryl;
each R³ is hydrogen or optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl);
each R is independently OR⁴, NR⁴₂ or SR⁴; and CH₂SiR⁴₃, where R⁴ is hydrogen, optionally substituted linear or branched C₁₋₁₈ alkyl (e.g., C₁₋₅ alkyl), such as a fluoro-substituted alkyl, or optionally substituted linear or branched (C₁₋₁₂)alkylcarbonyl (e.g., (C₁₋₅)alkylcarbonyl), such as C(O)CH₂OCH₃; and
each R⁵ is independently hydrogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl) or, when there is a C—N double bond, absent.

In accordance with another embodiment, the stereochemistry of R¹ is (R,R).

In accordance with another embodiment, the complex comprises a ligand selected from the following structures:

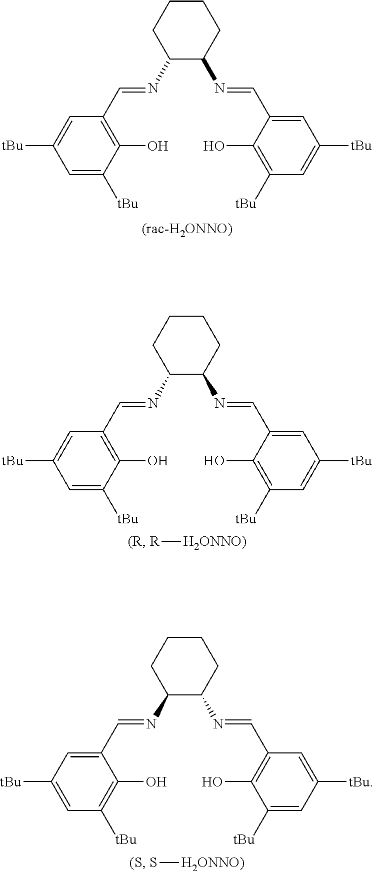

In accordance with another aspect, there is provided a method of making a complex having the structure of formula (Ia) or its corresponding dimer of formula (Ib):

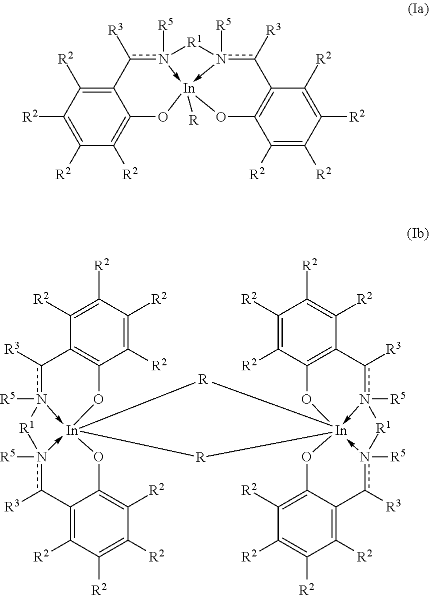

wherein

the dashed line represents an optional double bond;

R¹ is an optionally substituted C₂₋₅ alkylene,

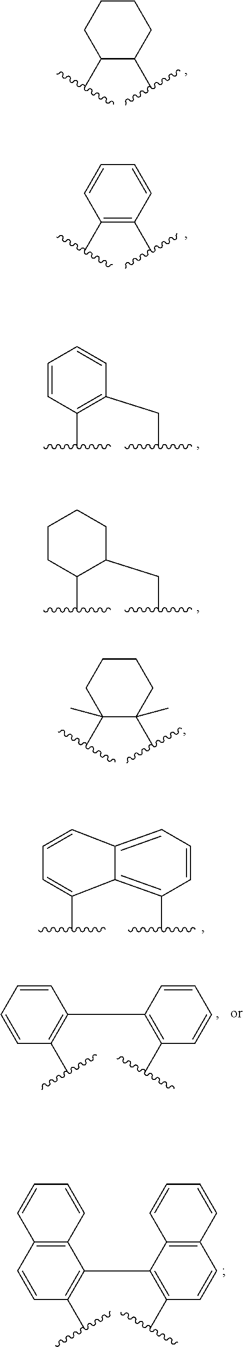

each R² is independently hydrogen, halogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl), optionally substituted phenyl or SiR′, where R′ is alkyl or aryl;

each R³ is hydrogen or optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl);

each R is independently OR⁴, NR⁴₂ or SR⁴; and CH₂SiR⁴₃, where R⁴ is hydrogen, optionally substituted linear or branched C₁₋₁₈ alkyl (e.g., C₁₋₅ alkyl), such as a fluoro-substituted alkyl, or optionally substituted linear or branched (C₁₋₁₂)alkylcarbonyl (e.g., (C₁₋₅)alkylcarbonyl), such as C(O)CH₂OCH₃; and

each R⁵ is independently hydrogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl) or, when there is a C—N double bond, absent,

comprising:

a) reacting a compound of formula (IIa) with a strong base to give a diphenoxide

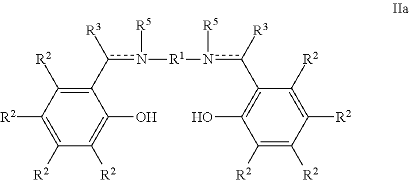

b) complexing the diphenoxide of step a) with an indium salt InX₃ to give an indium complex of formula (IIb),

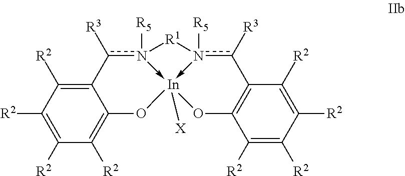

wherein X is an anion, and

c) reacting the indium complex of formula (IIb) with a salt of R⁴OM, wherein M is a metal cation, such as Li⁺, Na⁺ or K⁺, or NR⁶₄⁺, wherein R⁶ is an alkyl.

In one embodiment, the indium salt is InX₃, wherein each X is independently an acceptable anion, such as, but not limited to a halide (e.g., CL⁻), triflate or an alkoxide (e.g., ethoxide). In accordance with one embodiment, the indium salt is an indium halide. In one another embodiment, the indium salt is indium triflate. In one preferred embodiment, the indium salt is indium chloride.

In accordance with one embodiment of the above synthetic method, the method is for making a complex of formula (I)

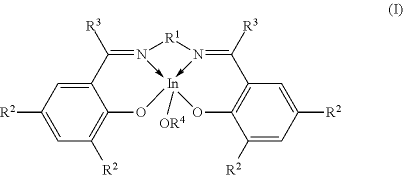

wherein
R¹, R², R³, R⁴, R⁵ and R are as defined above, and the method comprises:
a) reacting a compound of formula (Ma) with a strong base to give a diphenoxide

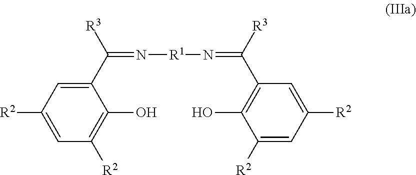

b) complexing the diphenoxide of step a) with an indium salt InX₃ to give an indium complex of formula (IIb),

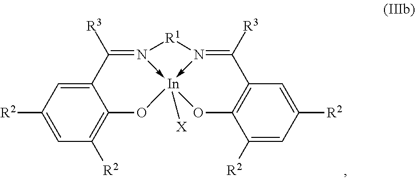

wherein X is an anion.
c) reacting the indium complex of formula (IIb) with a salt of R⁴OM, wherein M is a metal cation, such as Li⁺, Na⁺ or K⁺, or NR⁶₄⁺, wherein R⁶ is an alkyl.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 depicts the Oak Ridge Thermal Ellipsoid Plot (ORTEP) of the crystal structure of complex (R,R)—(ONNO)InCl which was obtained from rac-1. The unit cell contains both R,R and S,S molecules;

FIG. 2a depicts the molecular structure of (rac-2)₂ having a dimeric solid state structure depicted with ellipsoids at 50% probability, with hydrogen atoms and solvent molecules omitted for clarity;

FIG. 2b depicts an X-ray crystal structure of (R,R-2)₂ having a dimeric solid state structure with bridging ethoxide groups;

FIG. 3 depicts the ¹H NMR spectrum of the product of a polymerization reaction of rac-Lactide with rac-2;

FIG. 4 depicts the ¹H{¹H} NMR spectrum of the polymer methine region after polymerization of rac-Lactide with rac-2;

FIG. 5 depicts the ¹H NMR spectrum of the product of a polymerization reaction of rac-Lactide with (R,R)-2;

FIG. 6 depicts the ¹H{¹H} NMR spectrum of the polymer methine region after of polymerization of rac-Lactide with (R,R)-2;

FIGS. 7a and 7b depict ORTEP molecular structures of rac-1 (7a) and (rac-2) dimer (7b);

FIG. 8 depicts the connectivity data for of (R,R/S,S) dimer of complex 2, obtained from single crystals grown in hexanes at −35° C. for 3 days;

FIG. 9 graphically depicts a ROP plot of 200 equiv of [LA] vs. [initiator (R,R)-2];

FIG. 10 graphically depicts a ROP plots of 200 equiv of [LA] vs. [initiator rac-2];

FIG. 11 graphically depicts a ROP plot of varying equivalents of [rac-LA] with rac-2;

FIG. 12 graphically depicts a plot of Kobs vs [initiator] results for the dependence of the rate of rac-lactide polymerization on rac-2 concentration;

FIGS. 13a and 13b depict the ¹H{¹H} NMR (CDCl₃, 25° C.) spectra of methine regions for ROP of rac-LA with rac-2 (12a) at 97% conversion and (R,R)-2 (12b) at 96% conversion;

FIG. 14 depicts the ¹H{¹H} NMR spectra of the methine region for ROP of rac-LA with (R,R)-2 after (a) 11% (b) 24% (c) 47% (d) 60% (e) 97% conversion;

FIG. 15 graphically depicts a plot of the observed PLA Mₙ (ν) and molecular weight distribution (♦) as functions of added rac-LA for the catalyst rac-2 (Mₙ=number averaged molecular weight, PDI=polydispersity index). The line indicates calculated Mₙ values based on the LA:initiator ratio;

FIG. 16 graphically depicts a plot of Pₘ vs. conversion for polymerization of rac-LA with (R,R)-2;

FIG. 17 depicts a ¹H NMR spectrum of dimeric (R,R)—N,N′-Bis(3-adamantyl-5-tert-butyl-salicylidene)-1,2-cyclohexanediamino indium ethoxide;

FIG. 18 depicts a ¹H NMR spectrum of dimeric (R,R)—N,N′-Bis(3-bromo-5-tert-butyl-salicylidene)-1,2-cyclohexanediamino indium ethoxide;

FIG. 19 depicts a ¹H NMR spectrum of (R,R)—N,N′-3,5-cumyl-salicylidene)-1,2-cyclohexanediamino indium ethoxide, the spectrum suggests that this complex is monomeric as the methylene protons of the ethoxide group appears as a quartet in the ¹H NMR spectrum as opposed to two diastereotropic protons in other catalysts (which is indicative of free rotation of the ethoxide which is impeded in dimeric structures);

FIG. 20 depicts a ¹H NMR spectrum of dimeric (R,R)—N,N′-Bis(3-methyl-5-tert-butyl-salicylidene)-1,2-cyclohexanediamino indium ethoxide;

FIG. 21 depicts a ¹H NMR spectrum of (R,R)—N,N′-Bis(3-ethoxy-salicylidene)-1,2-cyclohexanediamino indium ethoxide;

FIG. 22 depicts an ORTEP of (R,R)—N,N′-Bis(3-methyl-5-tert-butyl-salicylidene)-1,2-cyclohexanediamino indium ethoxide depicted with ellipsoids at 50% probability (H atoms and solvent molecules omitted for clarity);

FIG. 23 depicts an overlay of ¹H{¹H} NMR spectra of the methine region of PLA from the ROP of rac-LA with four different (R,R)-catalysts;

FIG. 24 depicts ¹H NMR spectra comparing the proligand, catalyst and the product of the reaction of the (R,R)-2 complex with water (CDCl₃, 25° C., 400 MHz);

FIG. 25 depicts the ORTEP of crystals obtained from a (R,R)-2 catalyst mixture with water, which shows connectivity for the resulting (salen-InOH)₂ complex;

FIG. 26A depicts a ¹H NMR spectrum of the methine region of PLA formed from the bis-hydroxy complex shown in FIG. 25 and FIG. 26B depicts a ¹H{H} NMR spectrum of methine region of the same PLA;

FIG. 27 depicts a ¹H NMR spectrum of the product of polymerization of β-butyrolactone by (R,R)—N,N′-Bis(3,5-di-tert-butylsalicylidene)-1,2 cyclohexanediamine indium ethoxide catalyst;

FIG. 28 depicts ¹H NMR spectra from the synthesis of PLA/PHB blockcopolymers by (R,R)—N,N′-Bis(3,5-di-tert-butylsalicylidene)-1,2 cyclohexanediamine indium ethoxide catalyst, where the bottom spectrum is from the product of reaction after the polymerization of rac-LA, and the top spectrum is from the product of the overnight reaction after the addition of rac-BBL;

FIG. 29 depicts a Differential Scanning calorimetry (DSC) trace of PLA product generated under bulk conditions at 110° C. using an indium catalyst;

FIG. 30 depicts a DSC trace of PLA product generated in solution at 20° C. using (R,R)—N,N′-Bis(3,5-di-tert-butylsalicylidene)-1,2 cyclohexanediamine indium ethoxide catalyst;

FIG. 31 depicts a DSC trace of PLA product generated in larger scale solution process at 20° C. using (R,R)—N,N′-Bis(3,5-di-tert-butylsalicylidene)-1,2 cyclohexanediamine indium ethoxide catalyst;

FIG. 32 depicts a DSC trace of PLA product generated under bulk conditions at 180° C. using tin(II) 2-ethylhexanoate catalyst;

FIG. 33 depicts a DSC trace of PLA product generated in solution at 95° C. using tin(II) 2-ethylhexanoate catalyst; and

FIG. 34 depicts an ORTEP of [(R,R—ONNO)In(CH₂SiMe₃)] depicted with ellipsoids at 50% probability (H atoms were removed for clarity).

### DETAILED DESCRIPTION OF THE INVENTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

As used herein, “halogen”, “halide”, or “halo” refers to F, Cl, Br or I.

As used herein, “alkyl” refers to a linear, branched or cyclic, saturated, unsaturated, or partially unsaturated hydrocarbon group, which can be unsubstituted or is optionally substituted with one or more substituent. Examples of saturated straight or branched chain alkyl groups include, but are not limited to, methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-3-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl and 2-ethyl-1-butyl, 1-heptyl and 1-octyl. As used herein the term “alkyl” encompasses cyclic alkyls, or cycloalkyl groups. The term “cycloalkyl” as used herein refers to a non-aromatic, saturated monocyclic, bicyclic or tricyclic hydrocarbon ring system containing at least 3 carbon atoms. Examples of C₃-C₁₂ cycloalkyl groups include, but are not limited to, cyclopropyl, cyclobutyl, cyclopentyl, cyclohexyl, cycloheptyl, cyclooctyl, norbornyl, adamantyl, bicyclo[2.2.2]oct-2-enyl, and bicyclo[2.2.2]octyl.

As used herein, the term “alkenyl” refers to a straight, branched or cyclic hydrocarbon group containing at least one double bond which can be unsubstituted or optionally substituted with one or more substituents.

As used herein, “alkynyl” refers to an unsaturated, straight or branched chain hydrocarbon group containing at least one triple bond which can be unsubstituted or optionally substituted with one or more substituents.

As used herein, “allenyl” refers to a straight or branched chain hydrocarbon group containing a carbon atom connected by double bonds to two other carbon atoms, which can be unsubstituted or optionally substituted with one or more substituents.

As used herein, “aryl” refers to hydrocarbons derived from benzene or a benzene derivative that are unsaturated aromatic carbocyclic groups of from 6 to 100 carbon atoms, or from which may or may not be a fused ring system, in some embodiments 6 to 50, in other embodiments 6 to 25, and in still other embodiments 6 to 15. The aryls may have a single or multiple rings. The term “aryl” as used herein also includes substituted aryls. Examples include, but are not limited to phenyl, naphthyl, xylene, phenylethane, substituted phenyl, substituted naphthyl, substituted xylene, substituted phenylethane and the like. As used herein, “heteroaryl” refers to an aryl that includes from 1 to 10, in other embodiments 1 to 4, heteroatoms selected from oxygen, nitrogen and sulfur, which can be substituted or unsubstituted.

As used herein, “substituted” refers to the structure having one or more substituents. A substituent is an atom or group of bonded atoms that can be considered to have replaced one or more hydrogen atoms attached to a parent molecular entity. In the present case, a substituent does not negatively affect the connectivity of the ligand. Examples of substituents include, but are not limited to, aliphatic groups (e.g., alkyl, alkenyl, alkynyl, etc.), halide, carbonyl, acyl, dialkylamino, arylcarbonyloxy, alkoxycarbonyloxy, aryloxycarbonyloxy, alkoxycarbonyl, amido, alkylthiocarbonyl, alkoxy, aryloxy, phosphate ester, phosphonato, phosphinato, cyano, amino, acylamino, tertiary amido, imino, alkylthio, arylthio, sulfonato, sulfamoyl, tertiary sulfonamido, nitrile, trifluoromethyl, trifluoromethoxy, heterocyclics, aromatic, and heteroaromatic moieties, ether, ester, boron-containing moieties, tertiary phosphines, and silicon-containing moieties. Silicon-containing moieties include silylated complexes such as SiR₃ where R is an alkyl or aryl or combinations thereof.

The terms “dispersity” and “polydispersity” refer to the dispersions of distributions of molar masses (or relative molecular masses, or molecular weights) and degrees of polymerization in polymeric systems. (INTERNATIONAL UNION OF PURE AND APPLIED CHEMISTRY—Dispersity in polymer science IUPAC Recommendations 2009; Pure Appl. Chem., Vol. 81, No. 2, pp. 351-353, 2009) The polydispersity index (PDI) is defined as the weight-average molecular weight divided by the number-average molecular weight (M_{w}/Mₙ). Both the M_{w} and the Mₙ can be determined by gel permeation chromatography or GPC. GPC can also be used in conversion experiments to determine the molecular weights of polymer samples. Polydispersity can be measured using GPC, providing a distribution of molecular weights (Mₙ). Molecular weights are measured versus standards and corrected (Mₙ^{c}) for changes in elution times.

The term “tacticity,” as used herein, refers to the relative stereochemistry of adjacent chiral centres within a polymer. Two adjacent structural units in a polymer are referred to as a dyad. When the two structural units have the same stereochemistry, the dyad is a “meso” dyad. If the two adjacent structural units have different stereochemistry, the dyad is a “racemic” dyad. Isotacticity is the extent to which a polymer is isotactic, where an isotactic polymer is one composed of meso dyads. The degree of isotacticity of a polymer can be quantified using Pₘ values, where Pₘ is the probability of finding meso dyads in a polymer. A Pₘ of 1 is a polymer that is 100% isotactic and a Pₘ of 0.5 is a polymer with no tacticity, in other words it is atactic.

As used herein the term “indium salt” refers to any salt of indium capable of reacting with the salen ligands presently described to form an indium complex. It is understood that indium, which has a valence of +3, would be added to the reaction as InX₃, wherein each X is independently an acceptable anion. Acceptable anions for the indium salt can be, for example, halogen, alkoxide (e.g., ethoxide) or triflate.

Salen Indium Complexes

The term “salen ligand” is typically used to refer to a class of chelating ligands derived from salicylaldehydes, and their corresponding complexes. Salen ligands comprise two imine nitrogens. However, for the sake of simplicity, the terms “salen ligand” and “salen complex” are used to also refer to “salan” ligands and complexes, in which the two nitrogens are saturated (i.e., they include two amine nitrogens rather than two imine nitrogens) and “salalen” ligands and complexes, in which one nitrogen is an imine nitrogen and the other is an amine nitrogen.

Described herein are salen indium complexes that are useful as catalysts, for example, in stereoselective polymerization of lactide, methods of synthesis thereof, and methods of synthesizing isotactically enriched polylactic acid.

In accordance with one aspect, there is provided a complex having the structure of formula (Ia) and its corresponding dimer or formula (Ib):

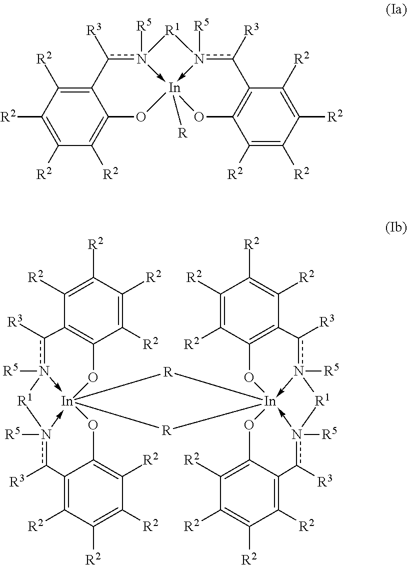

wherein

the dashed line represents an optional double bond;

R¹ is an optionally substituted C₂₋₅ alkylene,

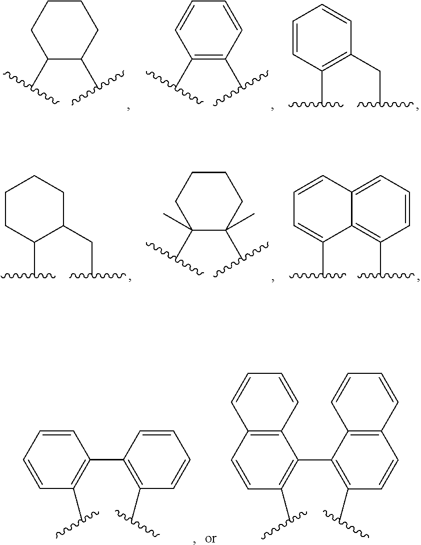

each R² is independently hydrogen, halogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl), optionally substituted phenyl or SiR′, where R′ is alkyl or aryl;

each R³ is hydrogen or optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl);

each R is independently OR⁴, NR⁴₂ or SR⁴; and CH₂SiR⁴₃, where R⁴ is hydrogen, optionally substituted linear or branched C₁₋₁₈ alkyl (e.g., C₁₋₅ alkyl), such as a fluoro-substituted alkyl, or optionally substituted linear or branched (C₁₋₁₂)alkylcarbonyl (e.g., (C₁₋₅)alkylcarbonyl), such as C(O)CH₂OCH₃; and

each R⁵ is independently hydrogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl) or, when there is a C—N double bond, absent.

In accordance with one embodiment, R¹ is a substituted C₂₋₅ alkylene, such as,

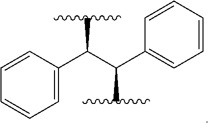 [SMILES: *[C@H](c1ccccc1)[C@H](*)c1ccccc1]

In accordance with one embodiment, the complex has one of the following structures:

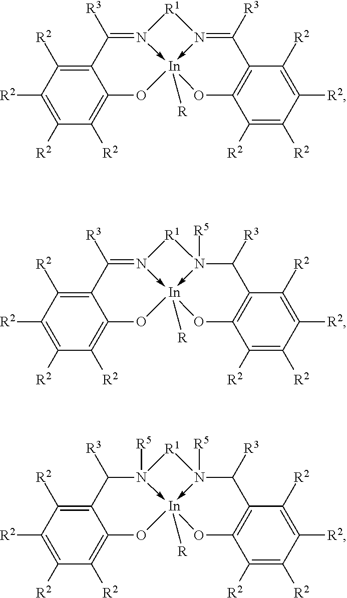

or
corresponding dimer of one of the above structures.

In an alternative embodiment, substituent R consists of a hemi-labile donor system. For example, when R is OR⁴, and R⁴ is an alkoxy substituted alkyl (e.g., alkoxy-substituted methyl), the monomeric form of the catalyst would have the following structure:

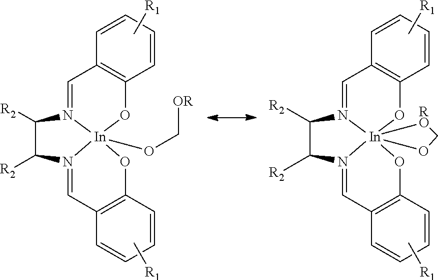

In this example, the complex can consist of both a 6 coordinate and 5 coordinate catalyst.

In accordance with certain alternative embodiments, the salen indium ligand comprises bridging ligands that are not based on alkoxides. For example, the bridging ligand can be a sulfide or an amide as shown in the following structures:

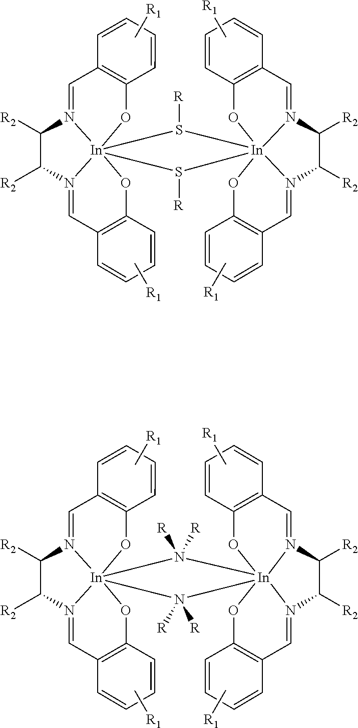

As would be readily understood by a worker skilled in the art, the dimeric catalyts can comprise two different salen ligands; it is not necessary for each indium centre to be complexed by the same ligand. The following structure generally illustrates a catalyst in dimeric form that comprises mixed salen ligands:

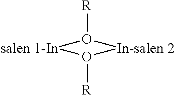

The dimeric catalyst can comprise mixed bridging ligands. More specifically, in the dimeric form of the catalyst, the two R substituents can be the same or different. This is illustrated in the structures of alternative embodiments of the present salen indium complexes shown below:

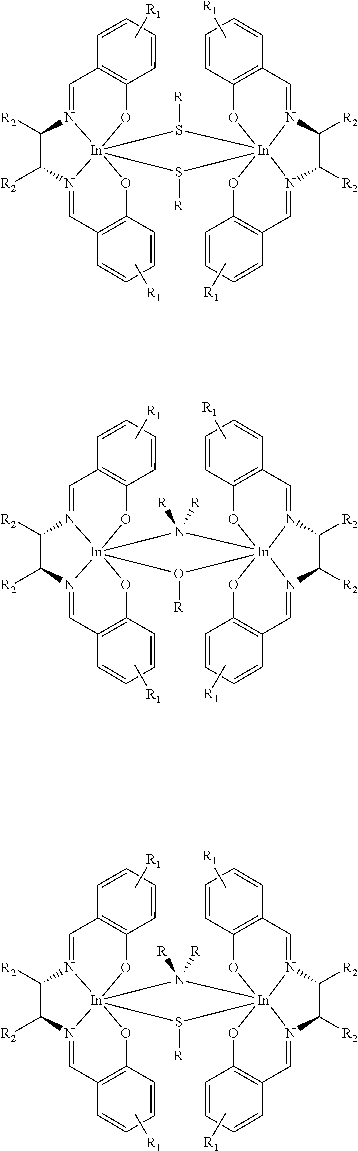

In accordance with one embodiment, the complex has the structure:

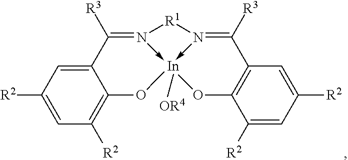

or the corresponding dimer.

In accordance with one embodiment, R¹ is

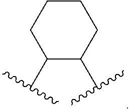 [SMILES: *C1CCCCC1*]

In accordance with another embodiment, at least R² is an optionally substituted C₁₋₅ alkyl, an optionally substituted aryl, an optionally substituted C₃-C₁₂ cyclic alkyl, or Si(aryl)₃; R³ is H and R⁴ is C₁₋₃ alkyl.

Specific, non-limiting, examples of chiral salen indium catalysts are:

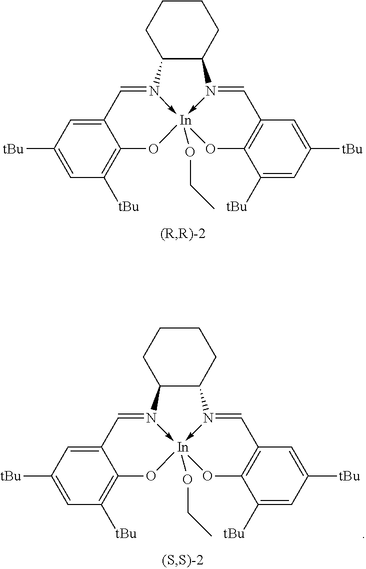

In one embodiment, the present catalysts provide isotactic enrichment of polylactic acid copolymer during polymerization with lactide. In accordance with one embodiment, the substituent R¹ is chiral, although this is not necessary for isotactic enrichment. In accordance with one embodiment, the stereochemistry of R¹ is (R,R). The catalysts having R,R configuration have been found to have a higher catalytic activity toward the polymerization of L-lactide, while catalysts having S,S configuration tend to favour D-lactide polymerization. Given the predominance of L-lactide (over D-lactide) in nature, it can be beneficial to make use of the R,R configuration. However, as noted above, this is not necessary in order to generate isotacticity in PLA, or other polymers. In fact, isotacticity can be readily obtained using a racemic or achiral (such as X═CH₂—CH₂ in the table below) salen indium catalyst irrespective of the stereochemistry of the monomers employed in the polymerization.

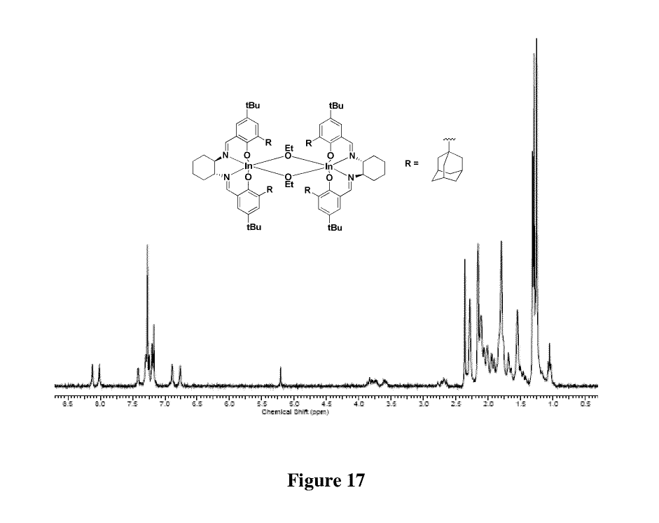

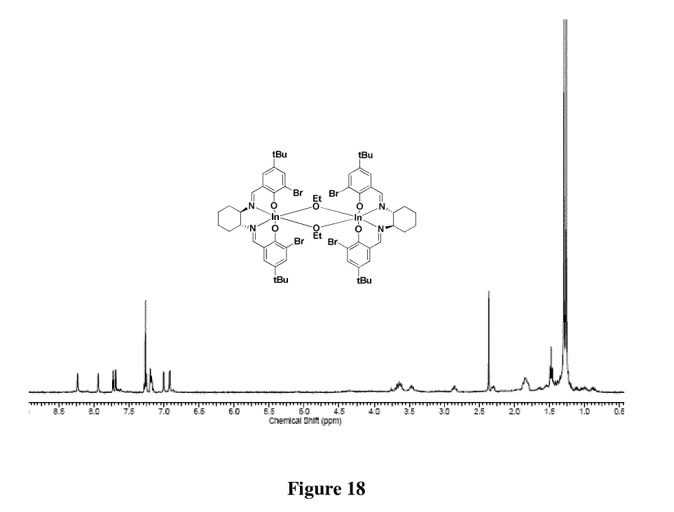

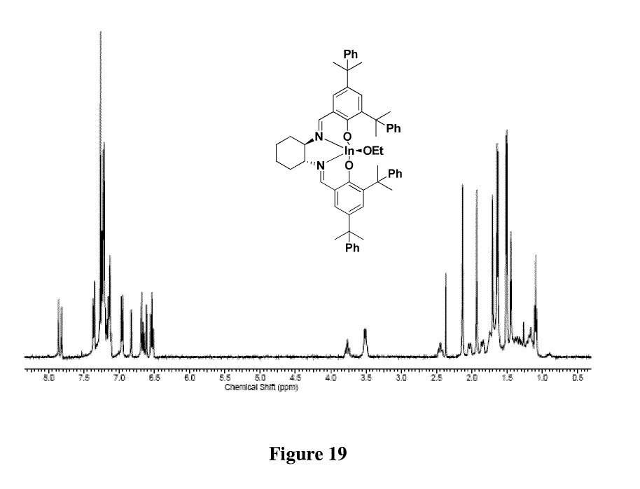

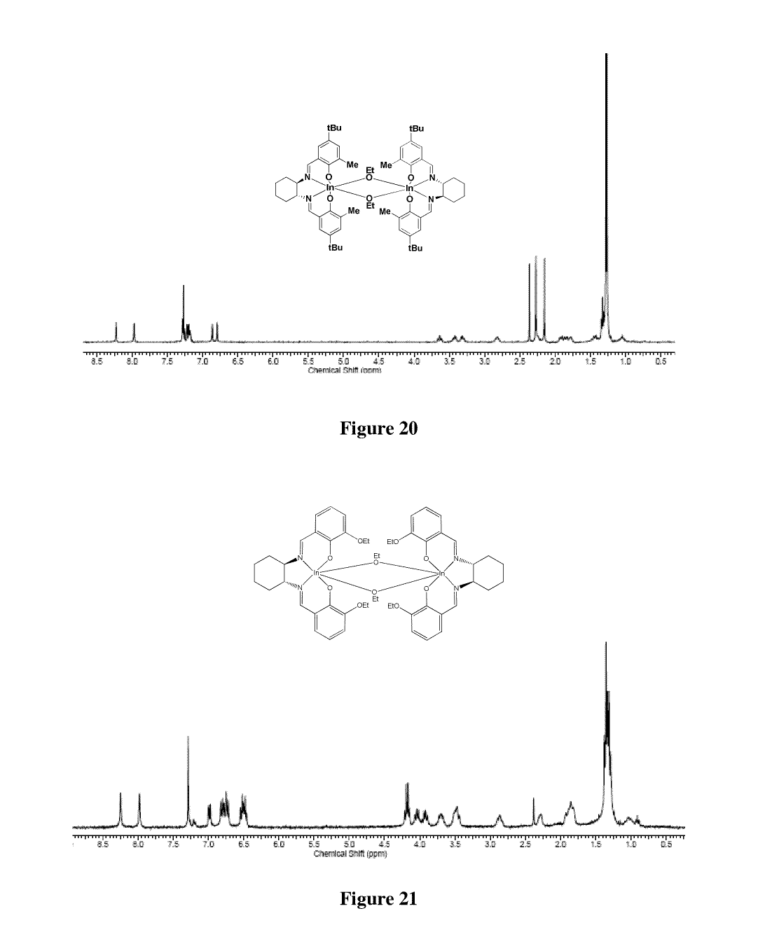

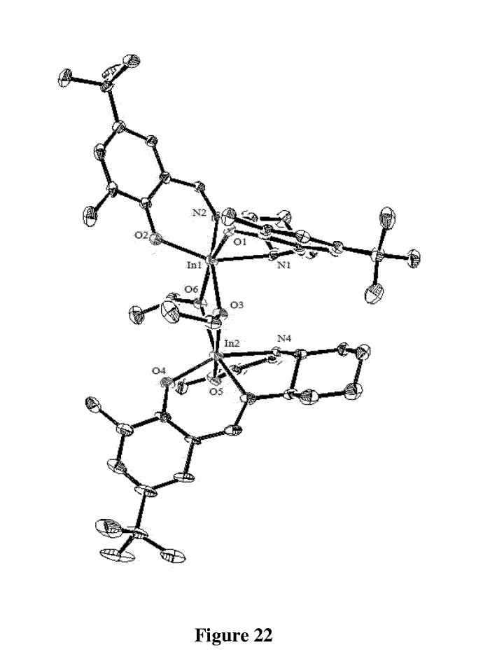

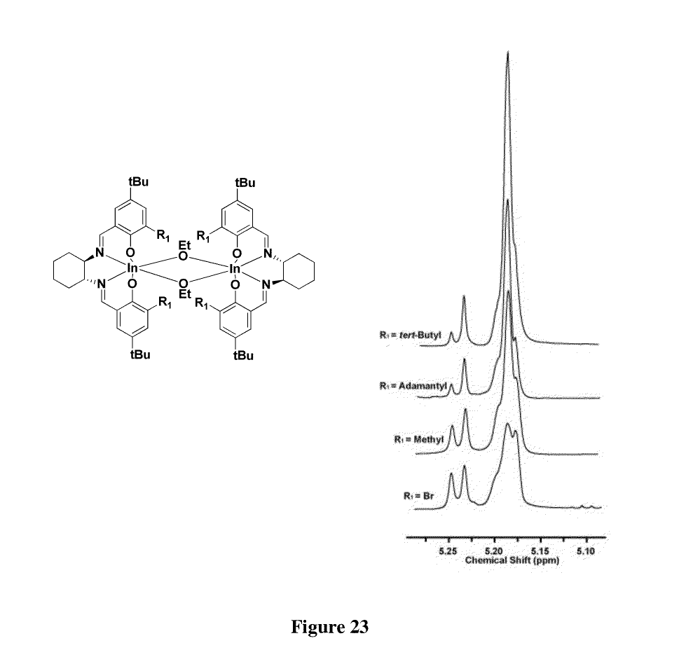

A summary of non-limiting examples of the present salen indium complexes is provided in the table below:

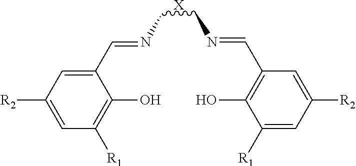

| | | | Characterizing | |
|---|---|---|---|---|
| R₁ | R₂ | X | NMR | Pm |
| t-butyl | t-butyl | cyclohexyl | | 0.77 |
| | | (R,R) | | |
| t-butyl | t-butyl | cyclohexyl (rac) | | 0.74 |
| methyl | t-butyl | cyclohexyl | FIG. 20 | 0.60 |
| | | (R,R) | | |
| Br | t-butyl | cyclohexyl | FIG. 18 | 0.52 |
| | | (R,R) | | |
| adamantyl | t-butyl | cyclohexyl | FIG. 17 | 0.76 |
| | | (R,R) | | |
| —OEt | H | cyclohexyl | FIG. 21 | 0.65 |
| | | (R,R) | | |
| —C(CH₃)₂Ph | —C(CH₃)₂Ph | cyclohexyl | FIG. 19 | 0.70 |
| | | (R,R) | (likely to | |
| | | | be monomeric | |
| | | | in solution) | |
| t-butyl | t-butyl | —CH₂CH₂— | | 0.66 |
| —Si(Ph)₃ | methyl | cyclohexyl | | |
| | | (R,R) | | |
| Ph | t-butyl | cyclohexyl | | |
| | | (R,R) | | |
| naphthyl | t-butyl | cyclohexyl | | |
| | | (R,R) | | |
| H | t-butyl | cyclohexyl | | |
| | | (R,R) | | |
| —C(Ph)₃ | t-butyl | cyclohexyl | | |
| | | (R,R) | | |
| t-butyl | t-butyl | binap (rac)* | | |
| methyl | t-butyl | binap (rac) | | |
| t-butyl | t-butyl | phenyl | | |

*binap = binaphthyl; rac = racemic

Most of the salen indium complexes described herein are dimers in solution and in the solid state. However, there are instances where the complex remains in a monomeric form. One example, is the complex comprising a ligand in which the R² substituents are cumyl functionalities. The ¹H NMR spectrum of this complex, shown in FIG. 19, suggests that this complex is monomeric as the methylene protons of the ethoxide group appears as a quartet in the ¹H NMR spectrum as opposed to two diastereotropic protons, as observed in other catalysts. This is indicative of free rotation of the ethoxide in the cumyl-containing ligand, which is impeded in dimeric structures. Without wishing to be bound by theory, It is possible that the cumyl group interferes with the formation of the dimer because of its steric bulk. Selection of appropriate substituents to either increase or decrease steric bulk in the ligand may assist in the design of salen indium complexes in monomeric or dimeric form, respectively.

Specific examples of ligands used in the salen indium complexes are depicted below:

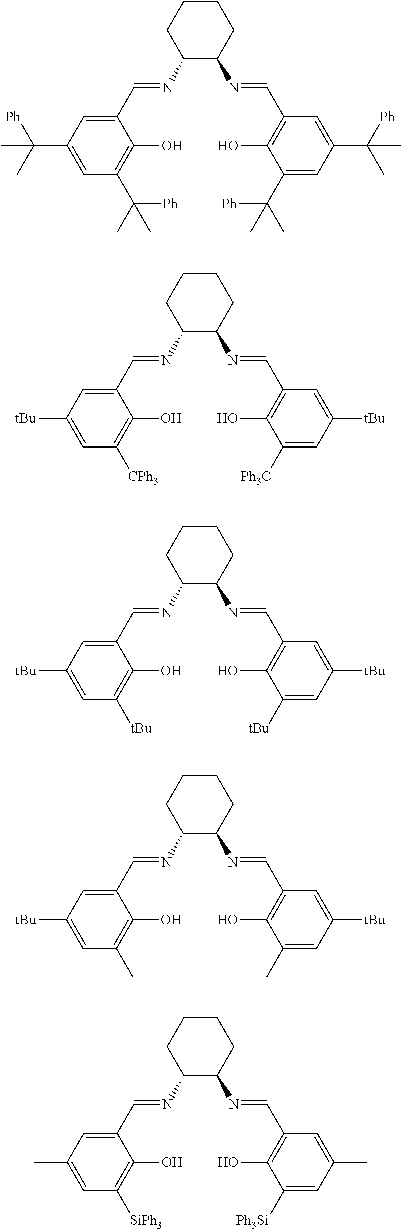

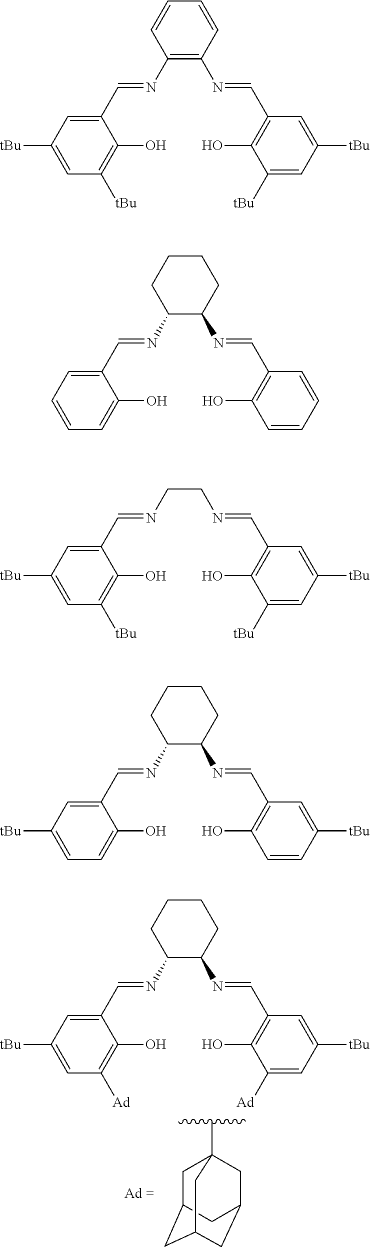

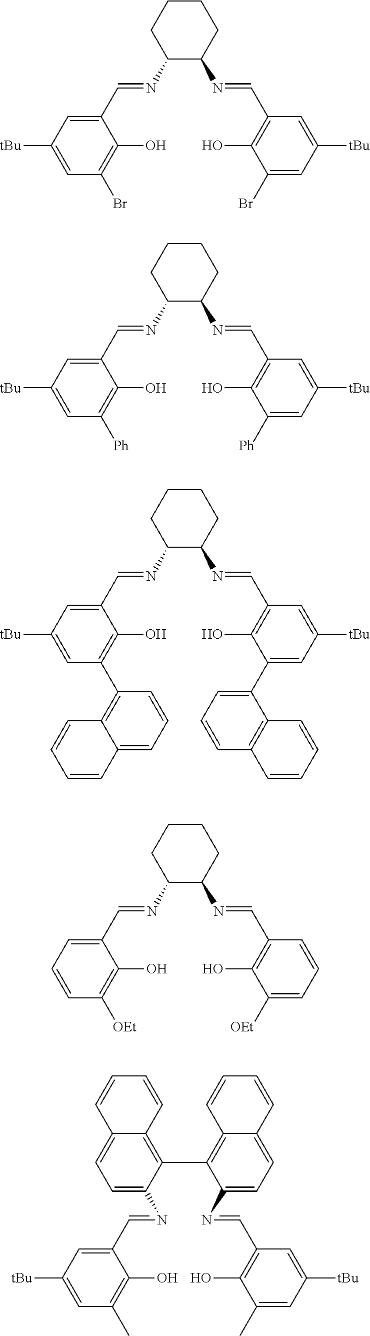

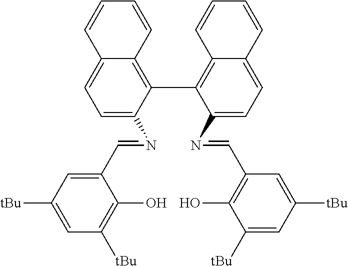

Polymerization and Copolymerization Methods

The salen indium complexes described in the previous section are effective catalysts for the ring opening polymerization of cyclic ester monomers. The polymerization methods described below can include copolymerization methods.

The present catalysts can be used for the polymerization of cyclic esters such as, for example, lactides, beta-butyrolactone and other cyclic esters such as caprolactones. Lactides useful in the present polymerization methods can be D-lactide, L-lactide, meso-lactide or rac-lactide. rac-lactide is a 50:50 mixture of D-lactide and L-lactide. In use in polymerizations, the lactide is often a mixture of D and L-lactides that is not a 50:50 mixture. For example, a common, commercially available lactide, that can be used in the polymerization methods described herein, is a mixture of 98% L-lactide and 2% D-lactide.

In some embodiments, the cyclic ester monomers used in the present polymerization methods include pendant functional groups. For example, a cyclic ester monomer used in a polymerization method can include pendant cross-linkable functional groups. This example, has the added advantage of being useful in methods for manufacturing cross-linked PLA.

In accordance with one embodiment, there is provided a method comprising polymerizing a cyclic ester monomer, or combination of cyclic ester monomers, with a salen indium catalyst, as described herein, under conditions suitable for ring-opening polymerization. A plurality of different cyclic ester monomers can be polymerized at the same time, or during different times of the entire polymerization process. In accordance with one embodiment, the polymerization is performed simultaneously using at least two different cyclic ester monomers in order to produce a random copolymer. In an alternative embodiment, as described in more detail below, two or more cyclic ester monomers are polymerized at different times during the polymerization process to produce a block copolymer.

Further, with regard to the copolymerization methods described in below embodiments, the first cyclic ester monomers can be polymerized in a solvent or solvent system and the second cyclic ester monomer is added to the solvent or solvent system (either directly or in a second miscible second solvent).

The ring-opening polymerization methods of the present invention can be living polymerization methods, that is, polymerizing steps can be living polymerizing steps in the methods disclosed herein.

Typically, in living polymerizations, cyclic ester monomer is polymerized at very low polymer chain termination rates (i.e., the ability of the growing polymer chains to terminate is substantially removed). The result can be that the polymer chains grow at a more constant rate (compared to traditional chain polymerization) and the polymer chain lengths remain very similar (i.e., they have a very low polydispersity index).

The ring-opening polymerization methods of the present invention can further be immortal ring opening polymerization methods, that is, polymerizing steps can be immortal polymerizing steps in the methods disclosed herein.

Typically, in immortal ring opening polymerization (iROP) of a cylic ester monomer, external nucleophiles act as both initiators and chain transfer agents in conjunction with a catalyst. The result can be that catalytic productivity is enhanced and metal contamination of polymers significantly reduced in comparison to classic living systems, while the polymer chain end is functionalized with the chosen chain transfer agent.

In accordance with a specific embodiment, there is provided a method of making polylactic acid comprising polymerizing lactide in the presence of a salen indium complex as described herein.

Polymerization reactions carried out using the salen indium complexes as presently described are well-controlled and polymers with high molecular weights and low molecular weight distributions can be obtained using the present methods. Preliminary kinetic investigations confirm that, as indicated above, enantiomorphic site control is the dominant contributor to selectivity. During polymerization, using a chiral catalyst, an enantiomorphic site control mechanism utilizes the chirality of the ancillary ligand, and hence, the catalyst itself is a source of stereochemical selectivity (due to steric interactions between the incoming monomer, the growing polymer chain bound to the metal centre, and the ancillary ligand). For example, preliminary kinetic studies have shown that the catalysts having ancillary ligands with the R,R configuration favour L-lactide monomers, while those catalysts with the S,S-configuration favour D-lactide monomers. During polymerization, using an achiral catalyst, reaction of the first monomer molecule with the catalyst complex imparts chirality on the catalyst leading to stereochemical selectivity towards incoming monomers.

Stereoselective ring opening polymerization of lactide can be carried out using the present methods of polymerization using the salen indium complex catalysts. In one embodiment, PLA is produced in a polymerization reaction of rac-lactide in the presence of a salen indium catalyst as described above, according to the following scheme:

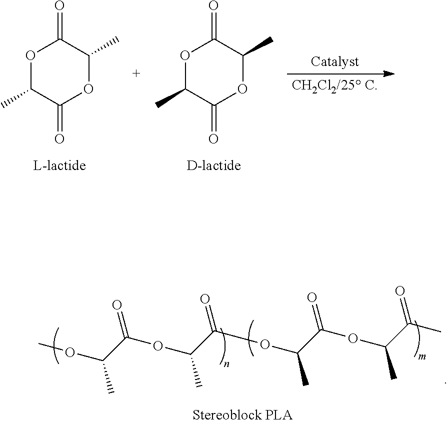

In accordance with another embodiment, the polylactic acid has a polydispersity index of less than about 2.0. In a preferred embodiment, the polylactic acid has a polydispersity index of less than about 1.7. In another preferred embodiment, the polylactic acid has a polydispersity index less than about 1.5.

In accordance with another embodiment, there is provided an isotactically enriched polylactic acid produced by the disclosed method. In one preferred embodiment, the isotactically enriched polylactic acid has a Pₘ, or isotacticity, of greater than 0.5, or between about 0.6-1.0. In another preferred embodiment, the isotactic enrichment is between about 0.7-1.0.

Polymerization reactions carried out using the presently described methods can be performed under a variety of conditions, and in any appropriate solvent. In one non-limiting embodiment, the appropriate solvent is CH₂Cl₂, tetrahydrofuran, toluene or benzene. In another non-limiting embodiment, the method can be carried out in a temperature range of 0-50° C. In one preferred embodiment, the method is carried out at about 25° C. In one preferred embodiment, the reactions are carried out at atmospheric pressure.

In an alternative embodiment, the polymerization reaction is performed using a bulk, or melt, process in which a salen indium complex is mixed with a cyclic ester monomer, or combination of monomers, in the absence of a solvent. The mixture is then heated to a temperature of greater than the melting point of the monomer, or combination of monomers, for an appropriate amount of time to allow the polymerization to proceed (e.g., an hour or more). In one embodiment, the melt polymerization process is performed at a temperature of about 100° C. or more, for example, at a temperature of from about 100° C. to about 250° C., or from about 100° C. to about 200° C. In specific examples, the melt polymerization is performed at about 110° C., or about 130° C., or about 160° C., or about 190° C.

In another embodiment, there is provided a copolymerization method for preparing a block copolymer, comprising:

(a) polymerizing a first cyclic ester monomer with a salen indium catalyst under conditions suitable for ring-opening polymerization of the first cyclic ester monomer to form a first polymer block of the block copolymer; and

(b) polymerizing a second cyclic ester monomer, different from the first cyclic ester monomer, with the salen indium catalyst under conditions suitable for ring-opening polymerization of the second cyclic ester monomer to form a second polymer block of the block copolymer.

The first cyclic ester monomer can be any cyclic ester monomer. Similarly, the second cyclic ester monomer can be any cyclic ester monomer. Suitable cyclic ester monomers that can be used in the present polymerization methods, including the first and/or the second step of the co-polymerization method, include, but are not limited to lactide, D-lactide, L-lactide, meso-lactide, rac-lactide, unequal mixtures of D- and L-lactide, or mixtures of D-, L- and meso-lactide. β-butyrolactone, or 4-(but-3-en-1-yl)oxetan-2-one In a specific embodiment, at least one of the first and second cyclic ester monomers used in the copolymerization method is a lactide. In a related embodiment, both the first and second cyclic ester monomers are lactides.

In a further embodiment, the copolymerization method can further comprise:

(c) polymerizing a third cyclic ester monomer, different from the first and second cyclic ester monomer, with a salen indium catalyst under conditions suitable for ring-opening polymerization of the third cyclic ester monomer to form a third polymer block of the block copolymer; and wherein the catalyst for step (c) is the same as the catalyst used in steps (a) and/or (b).

A further embodiment of the present invention is a polymerization method of anyone of the preceding embodiments, wherein an equal or greater ratio of chain transfer agent to salen indium catalyst is provided. The chain transfer agent is an alcohol, including, for example, an HO-polyester or HO-polyether. Suitable alcohols are RₙOH, where Rₙ is any alkyl chain, including straight and branched alkyl chains. In specific examples, the alcohol is ethanol, phenol, benzyl alcohol or isopropanol. In alternative examples, the alcohol is HO(CH₂)ₙOH, [HO(CH₂)ₙ]₃(CH) and [HO(CH₂)ₙ]₄(C) as well as other star shaped multiols. Polyesters can also be used, such as, for example, (OH-terminated PLA) or HO(CH₂O)ₙOH. A specific, non-limiting example of a suitable polyether is mPEG. In accordance with other embodiments, the chain transfer agent can be an amine, a thiol or a phosphine. A “high ratio” as referred to herein, typically, refers to a ratio that supports immortal polymerization. Typically, suitable ratios of chain transfer agent to salen indium catalyst are between about 100 and 1, between about 50 and 1; between about 20 and 1; between about 10 and 1; or between about 4 and 1.

Polylactic acid polymers produced by the presently described methods can have a polydispersity index of less than about 3.0. In a preferred embodiment, the polylactic acid has a polydispersity index of less than about 1.7. In another preferred embodiment, the polylactic acid produced by the presently described methods has a polydispersity index of less than about 1.5. In one embodiment, the polylactic acid produced by the presently described methods has a molecular weight of greater than about 300, or greater than about 10,000, or from about 300 to about 10,000,000, or from about 10,000 to about 1,000,000, or, more particularly, from about 20,000 to about 150,000, or, even more particularly, from about 28,800 to about 144,000. In another preferred embodiment, the polylactic acid produced by the presently described methods has a melting point of between about 130-178° C. In another preferred embodiment, the polylactic acid polymers produced by the presently described methods are white, or light yellow, in color.

Synthesis of Salen Indium Complexes

The present application further provides methods of producing the salen indium complexes described above.

In one embodiment, there is provided a method of synthesizing a complex having the structure of formula (Ia) and/or its corresponding dimer of formula (Ib):

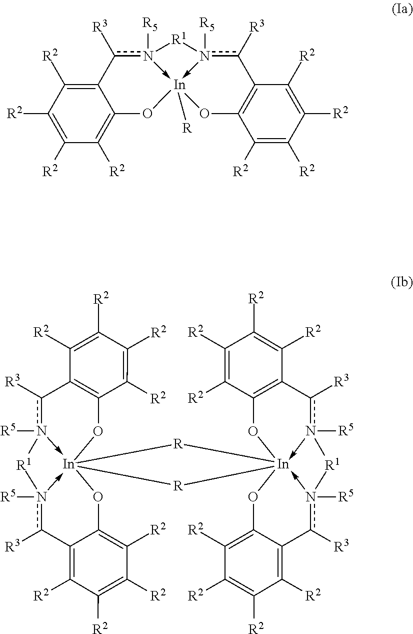

wherein

the dashed line represents an optional double bond;

R¹ is an optionally substituted C₂₋₅ alkylene,

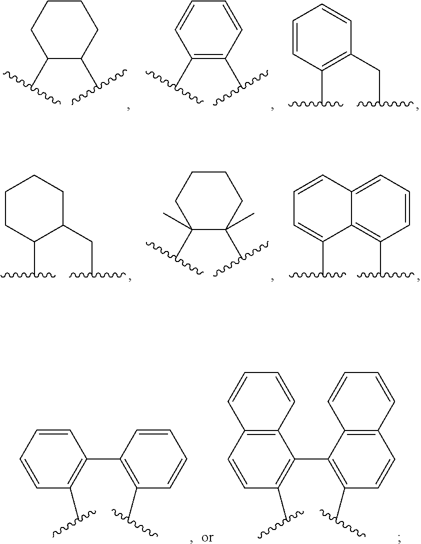

each R² is independently hydrogen, halogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl), optionally substituted phenyl or SiR′, where R′ is alkyl or aryl;

each R³ is hydrogen or optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl);

each R is independently OR⁴, NR⁴₂ or SR⁴; and CH₂SiR⁴₃, where R⁴ is hydrogen, optionally substituted linear or branched C₁₋₁₈ alkyl (e.g., C₁₋₅ alkyl), such as a fluoro-substituted alkyl, or optionally substituted linear or branched (C₁₋₁₂)alkylcarbonyl (e.g., (C₁₋₅)alkylcarbonyl), such as C(O)CH₂OCH₃; and

each R⁵ is independently hydrogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl) or, when there is a C—N double bond, absent,

comprising:

a) reacting a compound of formula (IIa) with a strong base to give a diphenoxide

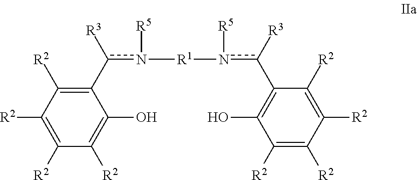

b) complexing the diphenoxide of step a) with an indium salt InX₃ to give an indium complex of formula (IIb),

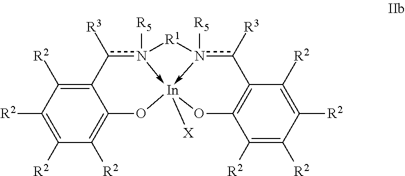

wherein X is an anion, and

c) reacting the indium complex of formula (IIb) with a salt of R⁴OM, wherein M is a metal cation, such as Li⁺, Na⁺ or K⁺, or NR⁶₄⁺, wherein R⁶ is an alkyl.

In one embodiment, the indium salt is InX₃, wherein each X is independently an acceptable anion, such as, but not limited to a halide (e.g., CL⁻), triflate or an alkoxide (e.g., ethoxide). In accordance with one embodiment, the indium salt is an indium halide. In one embodiment, the indium salt is indium triflate. In one preferred embodiment, the indium salt is indium chloride. Some examples of preferred acceptable anions are fluorine, chlorine, bromine, iodine, and triflate.

Generally, a salen indium complex as described herein, can be synthesized by reacting the corresponding salen ligand with two equivalents of PhCH₂K and subsequently reacting it with one equivalent of an indium salt. In one example, the salen ligand is converted to the corresponding phenoxide under basic conditions, and further reacted with indium chloride to give the corresponding salen indium chloride complex. This is then reacted with an alkoxide base to install the alkoxy functionality. The synthesis of one example catalyst, the (R,R)—N,N′-Bis(3,5-di-tert-butylsalicylidene)-1,2-cyclohexanediamine indium ethoxide complex, is shown below.

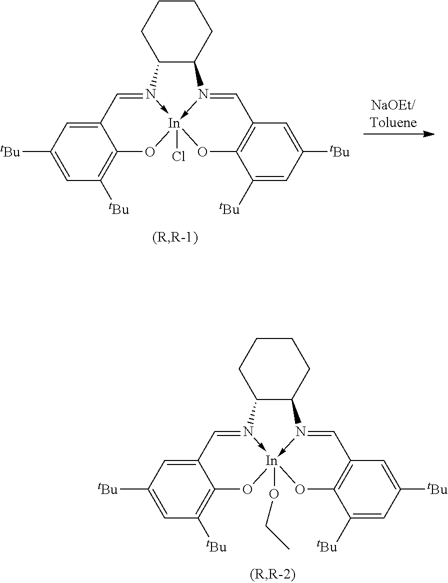

In another example, chiral indium salen chloride complexes having ligands with a binam backbone can be prepared according to the following general Scheme:

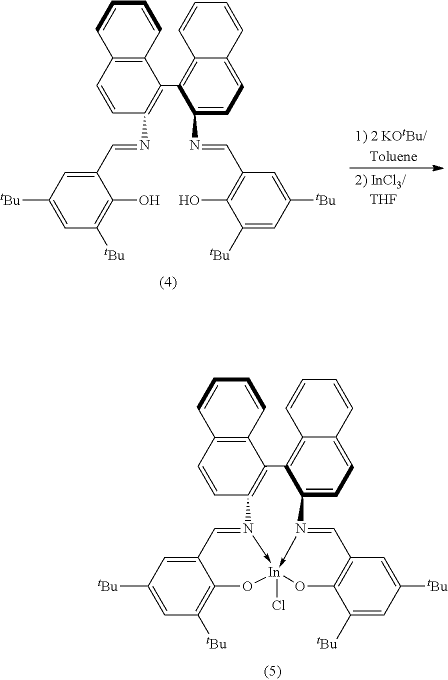

Ligand (4) in its racemic form can be been synthesized according to literature methods (Bernardo, K. D.; Robert, A.; Dahan, F.; Meunier, B. New J. Chem. 1995, 19, 129.) Chiral indium salen chloride complex (5) can be converted to indium salen alkoxide complex (6) according to the following scheme:

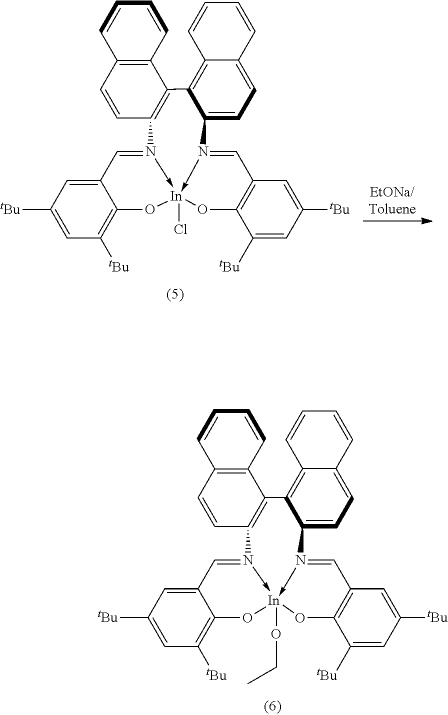

In an alternative embodiment, the salen indium catalysts can be synthesized using a one-pot synthesis. In particular, the above described three step synthesis of deprotonation of the salen ligand, reaction with InCl₃ to form the indium chloride complex and salt metathesis with NaOEt to form the indium alkoxide complex can be modified into a one-pot synthesis as outlined in the scheme below.

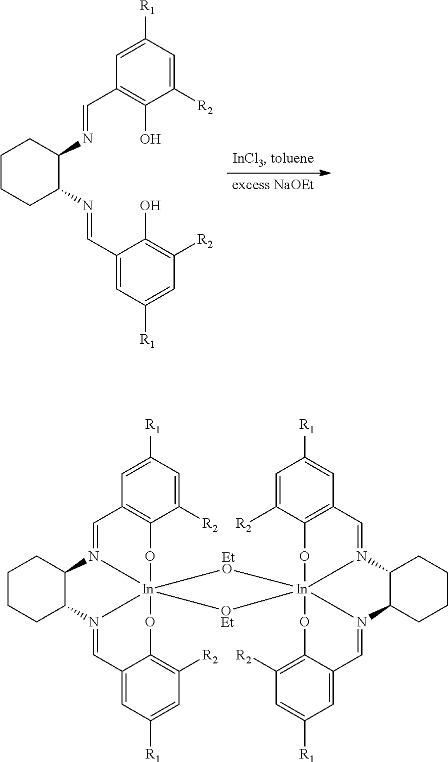

In accordance with one embodiment, the R substituent (i.e., the bridging ligand), is OH. The bis(hydroxide catalyst) can be prepared according to the following synthetic route:

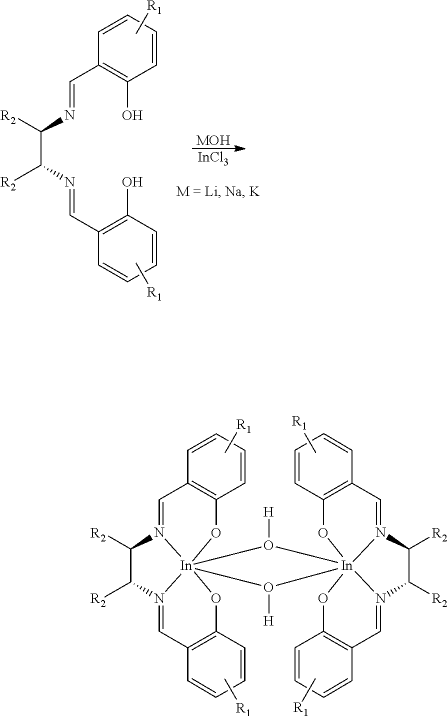

Additional synthetic routes for the manufacture of the salen indium complexes are summarized in the scheme below:

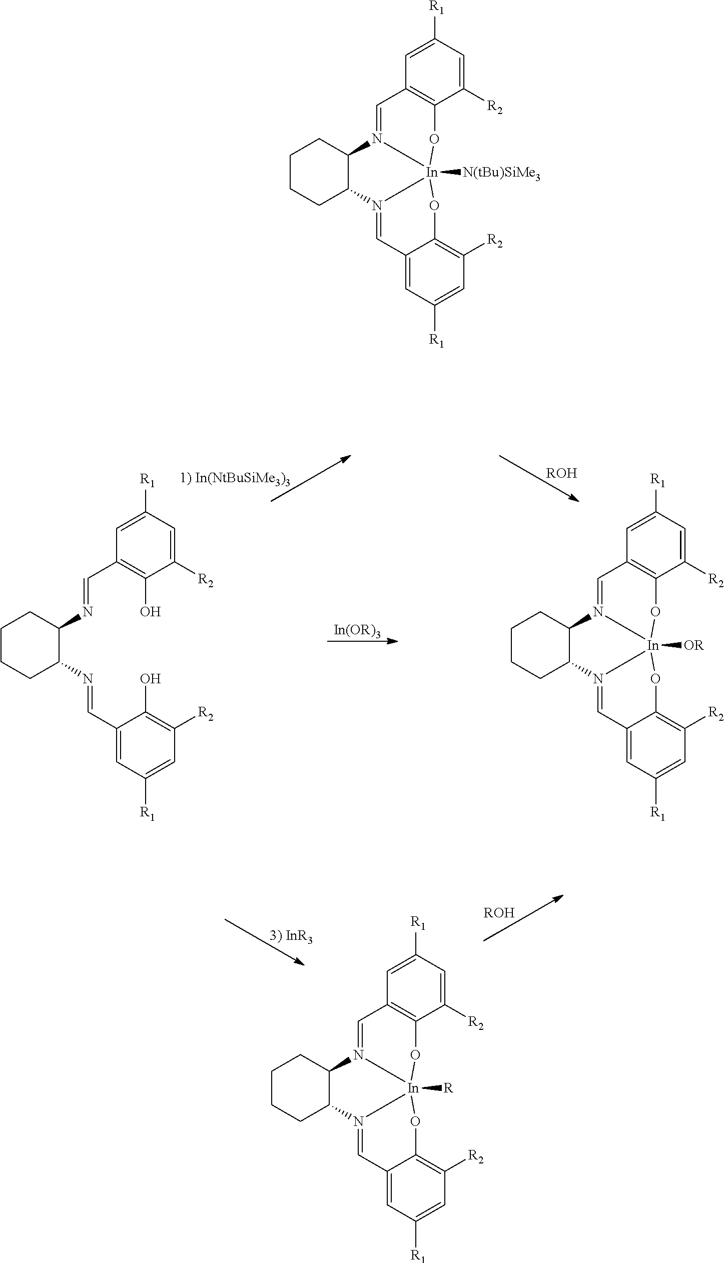

In another alternative, the salen indium catalyst can be prepared by a method that comprises pre-stirring the ligand and InCl₃ to form a dative bond between the nitrogen atoms of the ligand and indium centre. The subsequent addition of NaOEt base will deprotonate the phenolic protons, which will coordinate to indium centre and form a bridging alkoxy species with elimination of NaCl salt. This method is summarized in the scheme below:

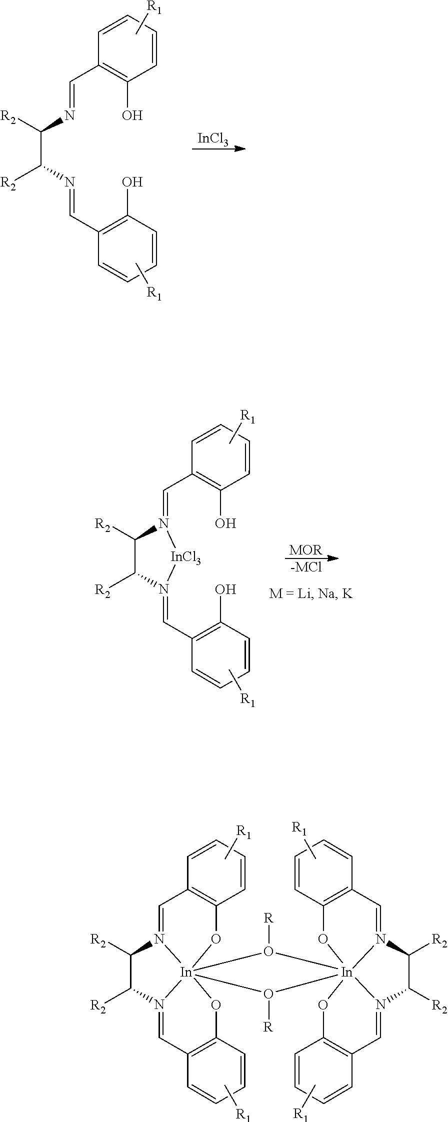

In another alternative method, the active salen indium catalyst can be prepared by hydrolysis of a precatalyst. An example of this method is illustrated in the scheme below:

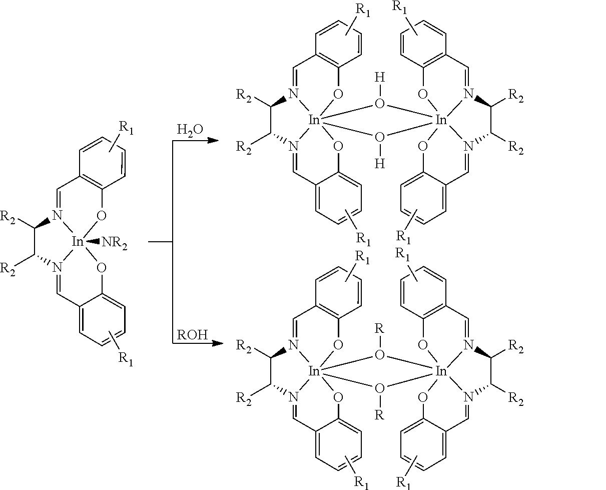

To gain a better understanding of the invention described herein, the following examples are set forth. It should be understood that these examples are for illustrative purposes only. Therefore, they should not limit the scope of this invention in any way.

### EXAMPLES

### Example 1

### General Considerations for Synthesis of Catalysts

Unless otherwise indicated, all air- and/or water-sensitive reactions were carried out under dry nitrogen using either an MBraun glove box or standard Schlenk line techniques. NMR spectra were recorded on a Bruker Avance 400 MHz and 600 MHz spectrometer. ¹H NMR chemical shifts are reported in ppm versus residual protons in deuterated solvents as follows: δ 7.27 CDCl₃, δ 5.32 CD₂Cl₂. ¹³C {¹H} NMR chemical shifts are reported in ppm versus residual ¹³C in the solvent: δ 77.2 CDCl₃, δ 54.0 CD₂Cl₂. Diffraction measurements for X-ray crystallography were made on a Bruker X8 APEX II diffraction with graphite monochromated Mo—Kα radiation.

The structures were solved by direct methods and refined by full-matrix least-squares using the SHELXTL crystallographic software of Bruker-AXS. Unless specified, all non-hydrogen were refined with anisotropic displacement parameters, and all hydrogen atoms were constrained to geometrically calculated positions but were not refined. EA CHN analysis was performed using a Carlo Erba EA1108 elemental analyzer.

The elemental composition of unknown samples was determined by using a calibration factor. The calibration factor was determined by analyzing a suitable certified organic standard (OAS) of a known elemental composition. Molecular weights were determined by triple detection gel permeation chromatography (GPC-LLS) using a Waters liquid chromatograph equipped with a Water 515 HPLC pump, Waters 717 plus autosampler, Waters Styragel columns (4.6×300 mm) HR5E, HR4 and HR2, Water 2410 differential refractometer, Wyatt tristar miniDAWN (laser light scattering detector) and a Wyatt ViscoStar viscometer. A flow rate of 0.5 mL min⁻¹ was used and samples were dissolved in THF (2 mg mL⁻¹). Narrow molecular weight polystyrene standards were used for calibration purposes. The molar mass was calculated with ASTRA© 5 software using the Mark-Houwink parameters (K=1.832×104 dL/g, a=0.69), laser light scattering detector data, and concentration detector. Distribution and moment procedures of ASTRA© 5 was used calculate molar mass moments Mn, Mw and Mz.

Solvents (THF, toluene, hexane and diethyl ether) were collected from an MBraun Solvent Purification System whose columns are packed with activated alumina. CH₂Cl₂ and CHCl₃ were purified following literature procedures to remove any impurities, dried over CaH₂ and degassed through a series of freeze-pump-thaw cycles. CD₂Cl₂, CDCl₃ and acetonitrile (CH₃CN) were dried over CaH₂, and degassed through a series of freeze-pump-thaw cycles. rac-LA was a gift from PURAC America Inc. and recrystallized twice from hot dried toluene. 1,3,5-trimethoxybenzene was purchased from Aldrich and used as received. KCH₂Ph was synthesized according to a previously reported procedure. In(CH₂SiMe₃)₃ was also synthesized according to a previously reported procedure (Beachley Jr., O. T., Rusinko, R. N. Inorganic Chemistry 1979, 18, 1966-1968).

### Example 2

### Preparation and Characterization of (ONNO)InCl Catalysts and Complexes

The tetradentate ligand (rac)-N,N′-Bis(3,5-di-tert-butylsalicylidene)-1,2-cyclohexanediamine and the enantiopure version of the same (R,R), were prepared using methods previously reported. (Jacobsen, E. N.; Organic Syntheses, 2004, Coll. Vol. 10, p. 96; Jacobsen, E. N.; Organic Syntheses, 1998, Vol. 75, p. 1).

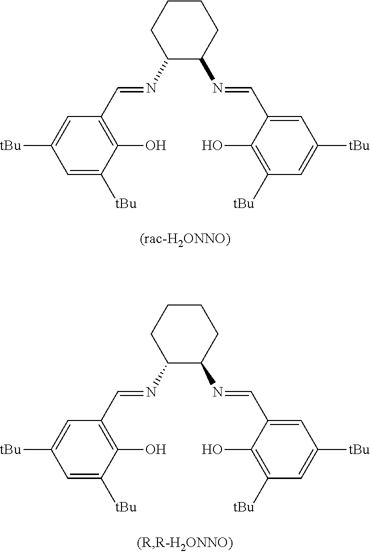 [SMILES: CC(C)(C)c1cc(/C=N/[C@@H]2CCCC[C@H]2/N=C/c2cc(C(C)(C)C)cc(C(C)(C)C)c2O)c(O)c(C(C)(C)C)c1 ; CC(C)(C)c1cc(/C=N/[C@@H]2CCCC[C@H]2/N=C/c2cc(C(C)(C)C)cc(C(C)(C)C)c2O)c(O)c(C(C)(C)C)c1]

Synthesis of Indium Chloride Complex (Rac)-(ONNO)InCl (Rac-1)

The salen indium chloride ligand [(rac)-(ONNO)InCl] complex (rac-1) was synthesized by reacting the corresponding salen ligand according to the following scheme:

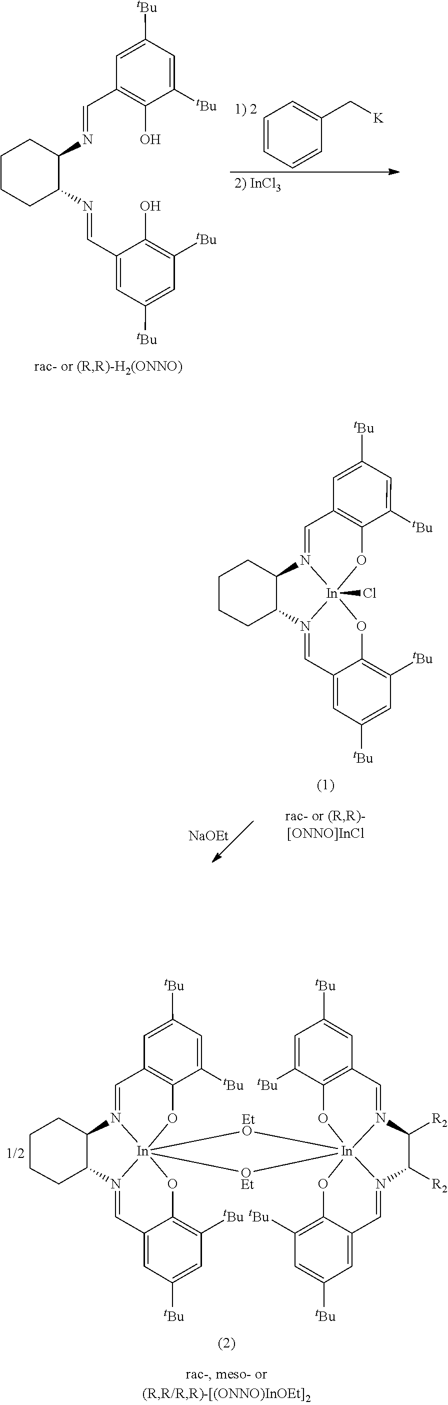

The racemic complex rac-1 was prepared and purified in an analogous manner from (rac)-H₂(ONNO) (1.05 g, 1.92 mmol) to afford 1.134 g (85% yield). Deprotonation of racemic N,N′-Bis(2,5-di-tert-butylsalicylidene)-1,2-cyclohexanediamine (rac-ONNO) with two equivalents of PhCH₂K, followed by addition of 1 equivalent of InCl₃ yields the racemic indium chloride derivative [(rac)-(ONNO)InCl] (rac-1).

The ¹H NMR spectrum (CDCl₃) of rac-1, which is identical to that of (R,R)-1 vide infra, shows two distinct imine proton signals as opposed to one peak in the proligand due to the loss of the C₂ rotational axis of ligand in the metal complex. The solid state structure of rac-1, determined by single crystal X-ray diffraction, confirms the solution studies.

Suitable crystals for X-ray diffraction were grown by slow diffusion. Yellow coloured X-ray quality crystals were obtained by crystallizing in diethyl ether for four days at −30° C. Anal. calcd (found) for C₃₆H₅₂N₂O₂InCl:C, 62.21 (62.19), H, 7.54 (7.50), N, 4.03 (4.06).

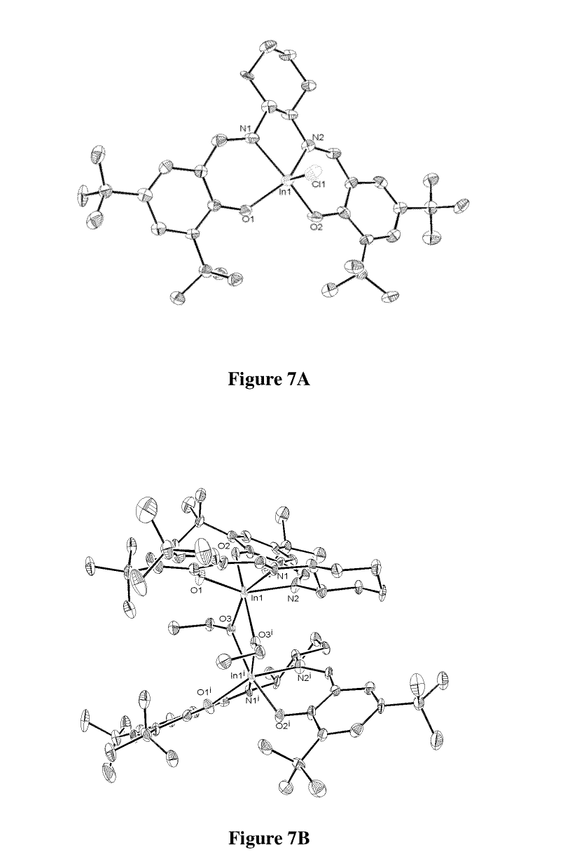

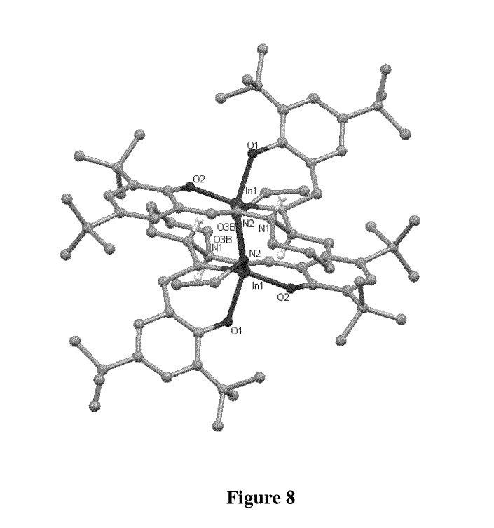

The molecular structure of (rac-1) is shown in FIG. 7a depicted with ellipsoids at 50% probability. (H atoms and solvent molecules omitted for clarity). Selected bond lengths (Å): In1-Cl1 2.371 (2), In1-O1 2.050 (6), In1-O2 2.044 (6), In1-N1 2.171 (7), In1-N2 2.207 (7). Selected bond angles)(°): O1-In1-Cl1 116.72 (19), O2-In1-Cl1 106.86 (19), N1-In1-Cl1 101.2 (2), N2-In1-Cl1 113.40 (19), O2-In1-O1 90.0 (2), O2-In1-N1 150.9 (3), O1-In1-N1 84.3 (3), O2-In1-N2 85.8 (2), O1-In1-N2 128.6 (3), N1-In1-N2 75.8 (3)

Synthesis of Indium Chloride Complex (R,R)—(ONNO)InCl (R,R-1)

The salen indium chloride complex (R,R-1) was synthesized by reacting the corresponding salen ligand with 2 equivalents of KCH₂Ph and subsequently reacting it with 1 equivalent of InCl₃ according to the following scheme:

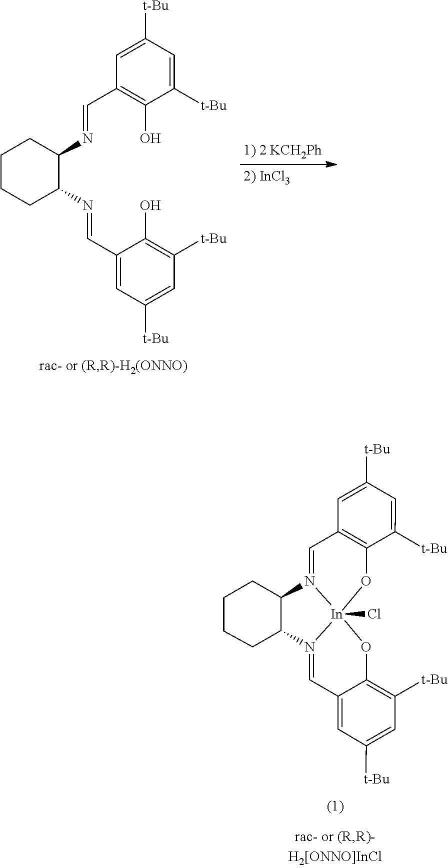

A solution of ligand (R,R-1) (R,R)—N,N′-Bis(3,5-di-tert-butylsalicylidene)-1,2-cyclohexanediamine (0.7252 g, 1.326 mmol) in toluene was added to a stirring slurry of KCH₂Ph (0.3451 g, 2.649 mmol) in toluene (total volume 25 mL) at room temperature. The resulting mixture was stirred at room temperature for 24 h. The solvent was subsequently evaporated under vacuum and the resulting solid was washed with cold hexanes and dried under vacuum to afford yellow solid (0.7812 g).

The resulting solid was added as a solution in THF to a stirring slurry of InCl₃ (0.2777 g, 1.255 mmol) in THF (total volume 25 mL) at room temperature. The resulting mixture was stirred at room temperature for 16 hours. The mixture was then filtered and the solution was dried under vacuum to afford a solid which was washed with cold hexanes and dried to obtain complex (R,R-1) as a yellow solid (0.7627 g, yield 83% with respect to rac-H2(ONNO)).

¹H NMR (300.13 MHz, CDCl₃): δ 8.42 (1H, s, N═CH), 8.21 (1H, s, N═CH), 7.51-7.50 (2H, d, ArH), 6.99 (1H, s, ArH) 6.95 (1H, s, ArH) 3.71-3.64 (1H, m, —CH— of DACH) 3.25-3.17 (1H, m, —CH— of DACH), 2.68-2.64 (1H, m, —CH₂— of DACH), 2.48-24.5 (1H, m, —CH₂— of DACH), 2.11-2.08 (2H, m, —CH₂— of DACH), 1.53-1.43 (4H, m, —CH₂— of DACH) 1.50 (9H, s, Ar—C(CH₃)₃), 1.49 (9H, s, Ar—C(CH₃)₃), 1.31 (9H, s, Ar—C(CH₃)₃), 1.30 (9H, s, Ar—C(CH₃)₃) ppm. ¹³C NMR (75.47 MHz, CDCl₃): δ 170.99, 167.75, 167.03, 142.64, 142.57, 137.73, 137.62, 130.62, 129.49, 117.50, 117.30, 65.05, 63.55, 35.68, 33.97, 31.35, 29.51, 28.63, 26.86, 24.21, 23.70. ppm Anal. calcd (found) for C₃₆H₅₂N₂O₂InCl: C, 62.21 (62.36), H, 7.54 (7.45), N, 4.03 (4.04).

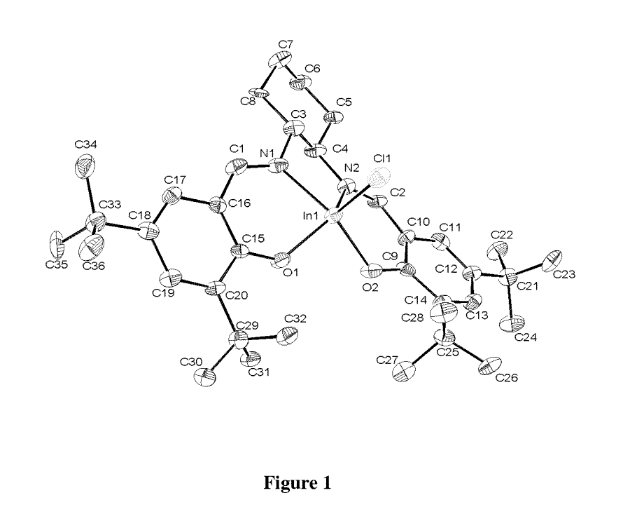

Yellow coloured X-ray quality crystals were obtained by crystallizing complex (R,R)—(ONNO)InCl in diethyl ether for four days at −30° C. A single crystal of (R,R)—(ONNO)InCl was studied by X-ray crystallography. The ORETP of the crystal structure of complex (R,R)—(ONNO)InCl is shown in FIG. 1.

Synthesis of Indium Ethoxide Complex (Rac)-(ONNO)InOEt (Rac-2)

The salen indium ethoxide [(ONNO)InOEt] catalyst (rac-1) was synthesized by reacting the corresponding salen indium chloro complex (rac-1) according to the following scheme:

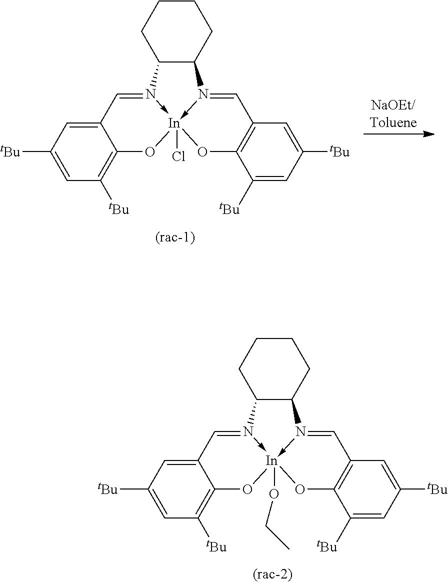

The racemic complex rac-(ONNO)InOEt (rac-2) was prepared and purified in an analogous manner to (R,R-2) (vide infra) in 81% yield with respect to rac-1. Suitable crystals for X-ray diffraction were grown by crystallizing in cyclohexane for three days at −30° C. The complex has an identical NMR spectrum to (R,R-2) (vide infra). Anal. calcd (found) for C₃₈H₅₇N₂O₃In: C, 64.77 (64.85), H, 8.15 (8.08), N, 3.98 (4.02).

The molecular structure of (rac-2) is shown in FIG. 7b, depicted with ellipsoids at 50% probability. (H atoms and solvent molecules omitted for clarity). Selected bond lengths (Å): O1-In1 2.080(5), O2-In1 2.128(5), O3-In1 2.121(5), N1-In1 2.259(6), N2-In1 2.206(6). Selected bond angles)(°): O1-In1-O3 109.79(19), O1-In1-O2 88.6(2), O3-In1-O2 93.08(19), O1-In1-N2 151.6(2), O3-In1-N2 97.1(2), O2-In1-N2 80.9(2), O1-In1-N1 84.8(2), O3-In1-N1 156.4(2), O2-In1-N1 106.1(2), N2-In1-N1 73.1(2).

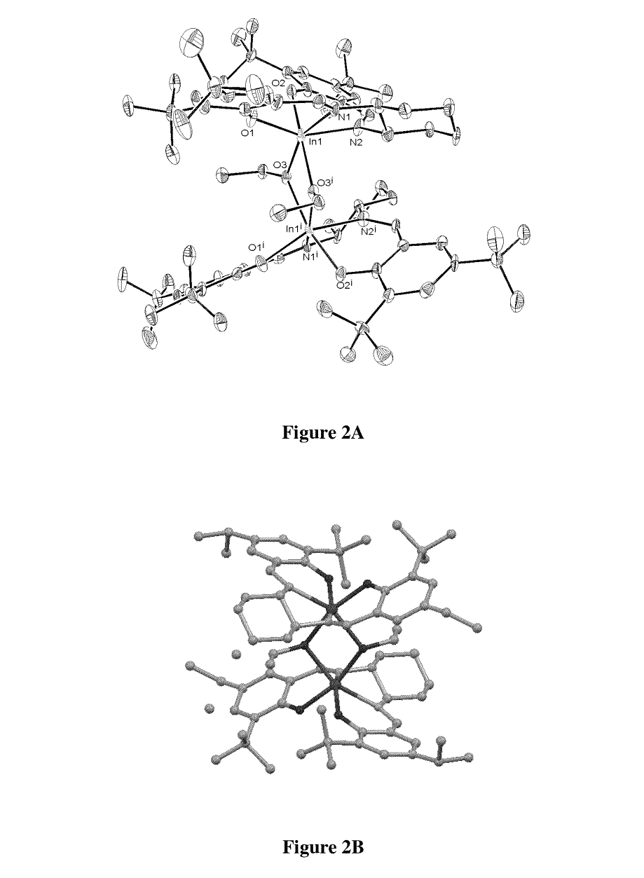

Rac-2 is dimeric in the solid state (denoted as (rac-2)₂), as shown by the structure determined by single-crystal X-ray diffraction in FIG. 2a. The solid-state structure of the (rac-2)₂ dimer shows two distorted octahedral centers bridged by two ethoxides. The coordinated cyclohexyldiamine for both indium centers have the same absolute configuration of (S,S/S,S), implying that the (R,R/R,R) homochiral dimer also exists. The (R,R/S,S) version of the complex can also be isolated

Selected crystallographic parameters for (rac-1) and (rac-2)₂ are shown in Table 1 below.

TABLE 1

| | rac-1 | (rac-2), |
|---|---|---|
| empirical formula | C₃₆H₅₂N₂O₂InCl | C₁₀₀H₁₆₂N₄O₆In₂ |
| fw | 695.07 | 1745.98 |
| T (K) | 90 | 100 |
| a (Å) | 12.805(3) | 29.058(1) |
| b (Å) | 26.307(6) | 17.6316(9) |
| c (Å) | 10.923(3) | 20.292(1) |
| a (deg) | 90 | 90 |
| b (deg) | 108.242(4) | 110.009(3) |
| g (deg) | 90 | 90 |
| volume (Å³) | 3495(2) | 9768.8(9) |
| Z | 4 | 8 |
| crystal system | monoclinic | monoclinic |
| space group | P 2₁/c (#14) | C 2/c (#15) |
| d_{calc} (g/cm³) | 1.321 | 1.187 |
| μ (MoKα) (cm⁻¹) | 7.85 | 5.23 |
| 2qmax (deg) | 45.1 | 45 |
| absorption correction | 0.498, 0.984 | 0.374, 0.990 |
| (Tₘᵢₙ, Tₘₐₓ) | | |
| total no. of reflections | 23431 | 68784 |
| no. of indep reflections | 4571 (0.102) | 6435, (0.141) |
| (Rᵢₙₜ) | | |
| residuals (refined on F², | 0.094; 0.161 | 0.094; 0.180 |
| all data): R₁; wR₂ | | |
| GOF | 1.03 | 1.11 |
| no. observations [I > 2s(I)] | 3314 | 4925 |

Synthesis of Indium Ethoxide Complex (R,R)—(ONNO)InOEt (R,R-2)

The salen indium ethoxide [(ONNO)InOEt] catalyst (R,R-2) was synthesized by reacting the corresponding salen indium chloro complex (R,R-1) according to the following scheme:

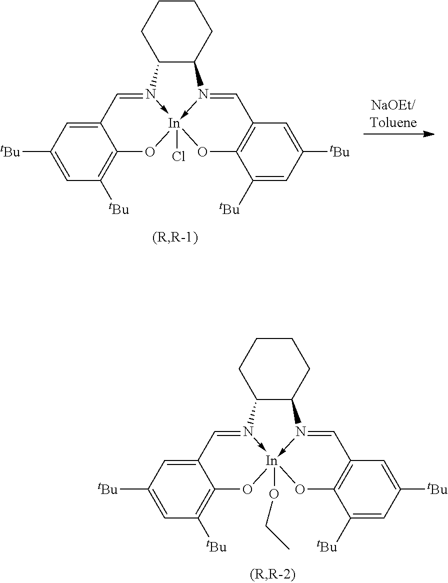

Indium chloride complex (R,R-1) was dissolved in toluene and added to a slurry of NaOEt (0.0746 g, 1.097 mmol) in toluene. The mixture was allowed to stir at room temperature for 48 h. The resulting mixture was filtered and the solution evaporated under vacuum to afford a solid which was washed with cold hexanes and dried to obtain a yellow solid (0.6389 g, overall yield 68% with respect to (R,R)—H₂(ONNO)).

¹H NMR (400.19 MHz, CDCl₃): δ 8.19 (1H, s, N═CH), 8.04 (1H, s, N═CH), 7.40-7.39 (1H, d, ArH), 7.38-7.37 (1H, d, ArH), 6.91-6.90 (1H, d, ArH), 6.77-6.76 (1H, d, ArH), 3.90-3.86 (1H, m, —CH— of DACH), 3.61-3.40 (2H, m, —CH₂— of —OCH₂CH₃), 3.76-3.72(1H, m, —CH— of DACH), 2.31-2.26 (1H, m, —CH₂— of DACH), 2.07-2.03 (1H, m, —CH₂— of DACH), 2.00-1.94 (1H, m, —CH₂— of DACH), 1.85-1.82 (1H, m, —CH₂— of DACH), 1.63-1.16 (4H, m, —CH₂— of DACH) 1.49 (9H, s, Ar—C(CH₃)₃), 1.30 (9H, s, Ar—C(CH₃)₃), 1.29 (9H, s, Ar—C(CH₃)₃), 1.27 (9H, s, Ar—C(CH₃)₃), 1.07 (3H, t, —CH₃ of —OCH₂CH₃) ¹³C NMR (100.63 MHz, CDCl₃): δ 170.53, 168.55, 168.23, 162.72, 141.99, 141.86, 135.18, 134.64, 129.27, 128.98, 128.26, 118.06, 117.52, 68.47, 62.77, 59.05, 35.78, 35.53, 33.83, 31.38, 30.67, 29.95, 29.69, 27.26, 24.78, 24.42, 20.88. Anal. calcd (found) for C₃₈H₅₇N₂O₃In: C, 64.77 (64.92), H, 8.15 (7.98), N, 3.98 (4.09).

Crystals of dimeric complex (R,R-2)₂ were obtained by crystallizing complex (R,R-2) in hexanes for three days to provide a dimeric solid state structure with bridging ethoxide groups, shown in FIG. 2b. This is a notable contrast with the reported solid state structures of dimeric aluminum salen type complexes where bridging between the two aluminum metal centers occurs via the ligand rather than the alkoxide. (Ovitt, T. M.; Coates, G. W. J. Am. Chem. Soc. 2002, 124, 1316.) This difference in the bridging mode is likely due to the increase in ionic radius between aluminum to indium.

Synthesis of ((R,R,)—ONNO)In(CH₂SiMe₃)

A 20 mL scintillation vial was charged with proligand R,R, —H₂(ONNO) (64.6 mg, 0.12 mmol) in Et₂O (3 mL). ((Trimethylsilyl)methyl)indium In(CH₂SiMe₃)₃ (67.7 mg, 0.18 mmol) was added to the stirring mixture dropwise. The reaction mixture was stirred for 16 h at room temperature. The solvent was removed to dryness in vacuo and then redissolved in acetonitrile (ca. 10 mL). The vial was kept in the freezer at −35° C. for 30 min Yellow crystals, which were used to collect X-ray crystallographic data, were formed. The collected crystals were washed with acetonitrile and dried under vacuum for several hours giving a yellow solid. ¹H NMR (400 MHz, CDCl₃): δ 8.28 (1H, ═NH), 8.10 (1H, ═NH), 7.40 (2H, ArH), 6.91 (1H, ArH), 6.85 (1H, ArH), 3.46 (1H, br. s., —CH— of DACH), 3.06 (1H, —CH— of DACH), 2.57 (1H, br. s., —CH₂— of DACH), 2.20-2.47 (1H, m, —CH₂— of DACH), 2.06 (2H, br. s., —CH₂— of DACH), 1.47 (22H, —CH₂— of DACH and Ar—(CH₃)₃), 1.29 (18H, Ar—(CH₃)₃), −0.16 (9H, —Si(CH₃)₃), −0.54-−0.31 (2H, In—CH₂—Si(CH₃)₃); Anal. Calcd. For C₄₀H₆₃InN₂O₂Si₂: C, 64.33; H, 8.50; N, 3.75. Found: C, 64.13; H, 8.41; N, 4.07.

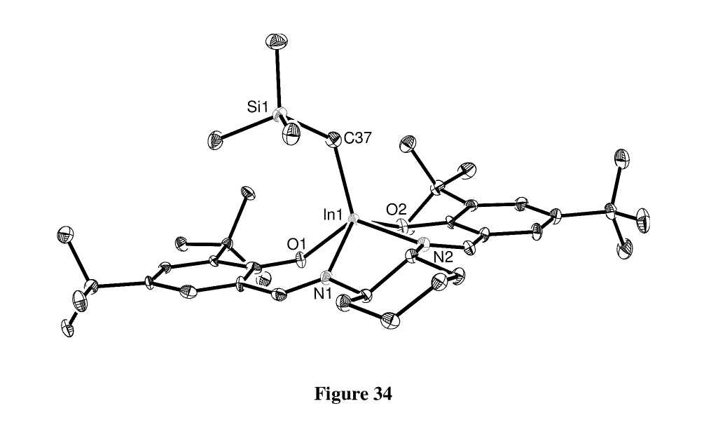

The ORTEP of [R,R—(ONNO)In(CH₂SiMe₃)] is shown in FIG. 34.

### Example 3

### Preparation and Characterization of Chiral Salen Indium Binam-Type Catalysts

Ligand (4) in its racemic form can be been synthesized according to literature methods (Bernardo, K. D.; Robert, A.; Dahan, F.; Meunier, B. New J. Chem. 1995, 19, 129.)

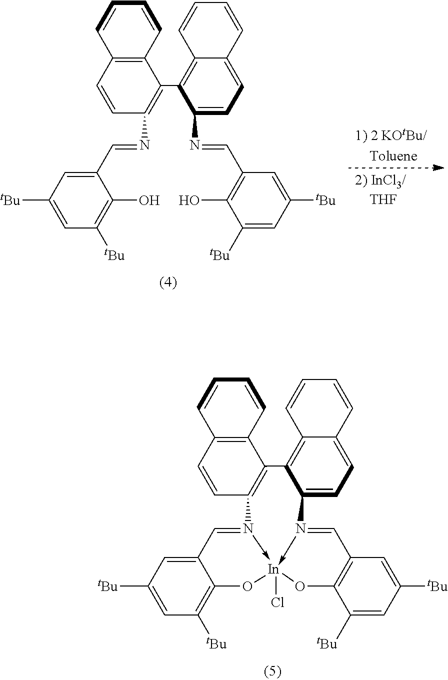

Ligand (4) (0.148 g, 0.207 mmol) was reacted with 2 equivalents of KO^{t}Bu(0.0465 g, 0.413 mmol) in toluene (5 mL) for 16 hours. The solvent was evaporated under vacuum to obtain a yellow residue. This was then was reacted with InCl₃ (0.0457 g, 0.207 mmol) in THF (5 mL) for 16 hours. The reaction mixture was evaporated under vacuum to obtain complex (5) as a yellow residue.

Chiral indium salen chloride complex (5) can be converted to indium salen alkoxide complex (6) according to the following scheme:

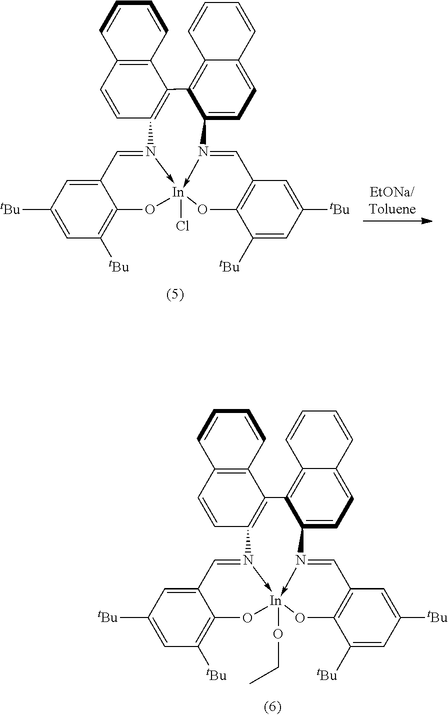

Complex (5) was reacted with NaOEt (0.015 g, 0.221 mmol) in toluene for 36 hours. The reaction mixture was subsequently evaporated under vacuum to obtain a yellow solid. The final product, catalyst (6), was successfully used to catalyze the polymerization of rac-LA.

### Example 4

### One-Pot Synthesis of Catalysts

All reactions and manipulations were performed under a dry nitrogen atmosphere using a glovebox or standard Schlenk line techniques unless stated otherwise. Anhydrous toluene and hexane solvents were collected from a solvent purification system, degassed via three successive freeze-pump-thaw cycles and stored over 4 Å molecular sieves. Sodium ethoxide and indium trichloride were purchased from Aldrich and dried under vacuum at 80° C. for 2 days. Indium triethoxide was purchased from Alfa Aesar and used as received. NMR spectra were recorded on a Varian 400 MHz NMR spectrometer at ambient temperature and pressure.

### (R,R)—N,N′-Bis(3,5-di-tert-butylsalicylidene)-1,2-cyclohexanediamine indium ethoxide complex

(R,R)—N,N′-Bis(3,5-di-tert-butylsalicylidene)-1,2-cyclohexanediamine was prepared following a literature procedure (Larrow, J. F.; Jacobsen, E. N. Org. Synth. 2004, Coll. Vol. 10, 96.). The recrystallized product was dried under vacuum at 50° C.

Dimeric (R,R)—N,N′-Bis(3,5-di-tert-butylsalicylidene)-1,2-cyclohexanediamino indium ethoxide was prepared from (R,R)—N,N′-Bis(3,5-di-tert-butylsalicylidene)-1,2-cyclohexanediamine according to the reaction shown in the following scheme.

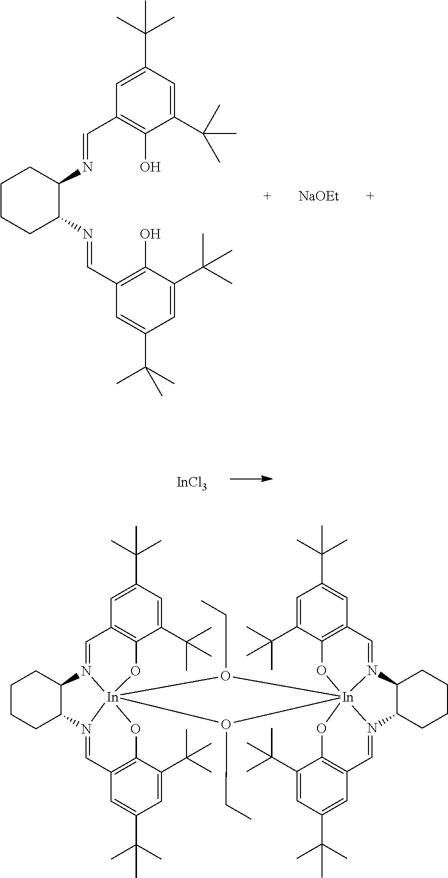

(R,R)—N,N′-Bis(3,5-di-tert-butylsalicylidene)-1,2-cyclohexanediamine (9.81 g, 17.9 mmol) was combined with sodium ethoxide (6.11 g, 90.0 mmol) and indium trichloride (4.17 g, 18.9 mmol), followed by addition of toluene (100 mL) to give an orange suspension. The mixture was stirred at room temperature for 18 h to yield a yellow solution with light yellow precipitate. The precipitate was removed by filtration and the filtrate dried under vacuum. The resulting yellow solid was then extracted with hexanes (150 mL), filtered and the filtrate dried under vacuum at 60° C. for 2 days. It was then re-dissolved in toluene (50 mL) in order to form an azeotropic mixture with trace ethanol byproduct, and was then removed by vacuum. The solid was dried at 65° C. for an additional 3 days giving the final product as a bright yellow powder (9.63 g, 6.83 mmol) with 76% isolated yield. The ¹H NMR spectrum matched that of the product from the multi-step synthesis reported vide supra.

The trace ethanol byproduct can be minimized by using 1.5 molar equivalents of indium trichloride and 4.5 molar equivalents of sodium ethoxide instead of 1.05 molar equivalents and 5 molar equivalents, respectively, as reported above.

### (R,R)—N,N′-Bis(3-methyl-5-tert-butyl-salicylidene)-1,2-cyclohexanediamino indium ethoxide

A 20 mL scintillation vial was charged with (R,R)—N,N′-Bis(3-methyl-5-tert-butyl-salicylidene)-1,2-cyclohexanediamine (100 mg, 0.216 mmol), anhydrous indium trichloride (48 mg, 0.216 mmol), 6 eq. of sodium ethoxide (88.2 mg, 1.3 mmol), 7 mL toluene, and a stir bar. The mixture was vigorously stirred at room temperature overnight, and filtered to remove the solids. The solvent was removed in vacuo from the solution to yield yellow solid (86.7 mg, 65%). Anal. Calcd for C₃₂H₄₅InN₂O₃: C, 61.94; H, 7.31; N, 4.51. Found: C, 60.78; H, 7.27; N, 3.95.

### Example 5

### Ring Opening Polymerization (ROP) of Lactide: In Situ Studies

All samples for NMR scale polymerizations were prepared in Teflon sealed NMR tubes under a N2 atmosphere. The NMR tube was charged with a stock solution of catalyst in CD₂Cl₂ (0.25 mL, 0.0023 mmol) and frozen. Then a 0.25 mL of CD₂Cl₂ was added and frozen to create a buffer between the catalyst and the lactide monomer. Finally the stock solution with rac-lactide (0.50 mL, 0.45 mmol) and the internal standard 1,3,5-trimethoxybenzene (5 mg, 0.03 mmol per 0.50 mL) was added and frozen. The sealed and evacuated NMR tube was immediately taken to the NMR spectrometer (400 MHz Avance Bruker Spectrometer) to monitor the polymerization at 25° C.

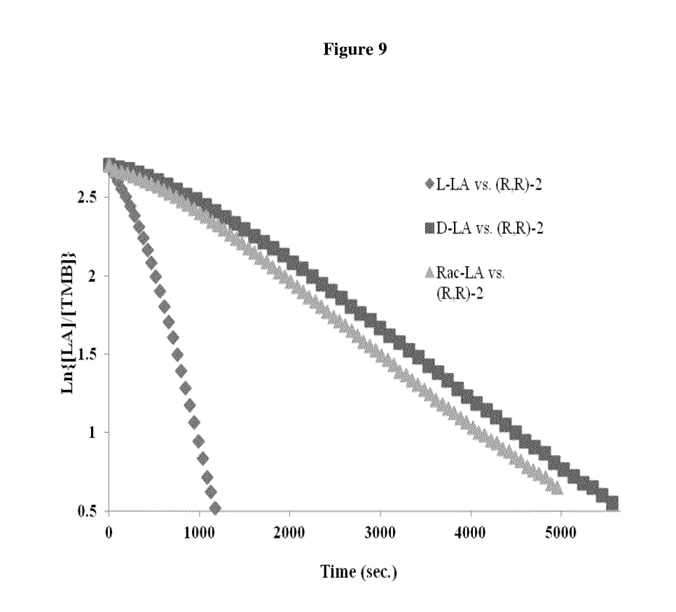

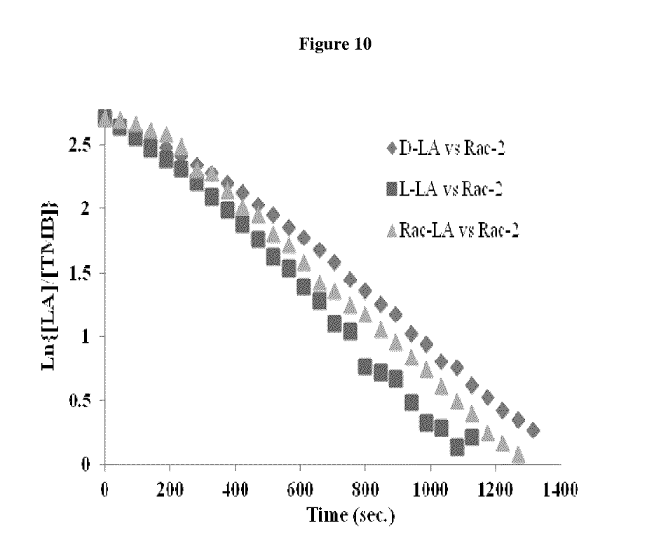

The results of the ring opening polymerizations of 200 equiv of [LA] vs. [initiator] are shown in FIG. 9 (for R,R-2) and FIG. 10 (for rac-2). All reactions were carried out with 200 equiv of LA in CD₂Cl₂ at 25° C. and followed to 90% conversion by ¹H NMR spectroscopy. [catalyst]=0.0023 M, [LA]=0.45 M. The value of k_{obs} was determined from the slope of the plots of ln([LA]/[TMB]) vs. time.

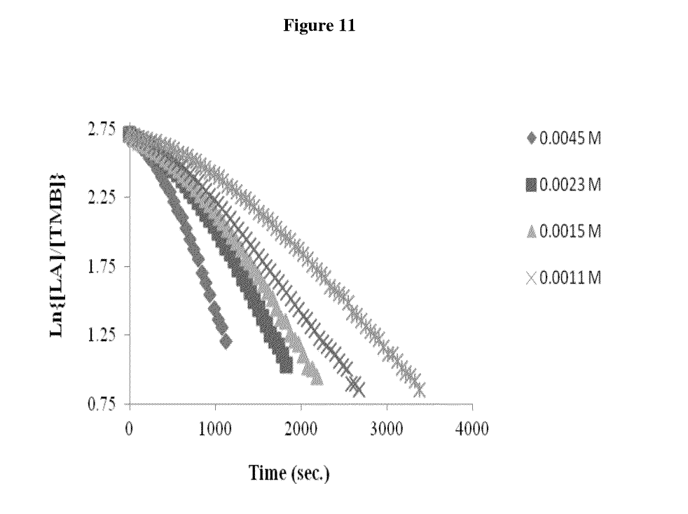

A similar investigation was carried out with different equivalents of rac-2 relative to racemic lactide (rac-LA) giving the ROP plots of rac-LA with rac-2. All reactions were carried out on an NMR scale with various ratios of [LA]/[initiator] at 25° C. and followed to 90% conversion. [LA]=0.91 M. [catalyst stock solution]=0.0091. The value of k_{obs} was determined from the slope of the plots of ln([LA]/[TMB]) vs. time. Results of the ring opening polymerizations are shown in FIG. 11.

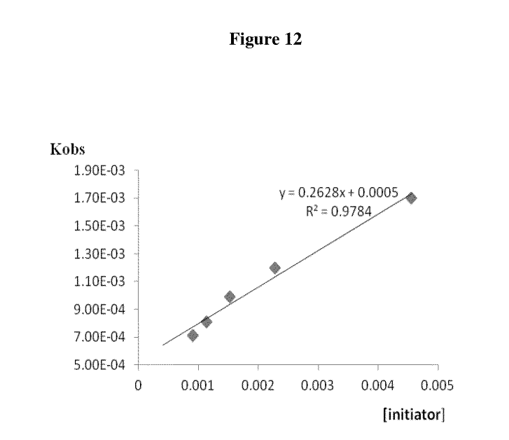

The dependence of the rate of rac-lactide polymerization on rac-2 concentration was also investigated. A plot of K_{obs} vs [initiator] is shown in FIG. 12.

### Example 6

### ROP of Lactide: Samples for GPC and ¹H(¹H) NMR Studies

All homonuclear decoupled ¹H NMR spectra were performed on a Bruker Avance 600 MHz spectrometer with a cryoprobe. The Pₘ and Pᵣ values were calculated from the following formulas which are based on tetrad probabilities in the polymerization of rac-lactide as calculated from Bernoullian statistics. (Chamberlain, B. M.; Cheng, M.; Moore, D. R.; Ovitt, T. M.; Lobkovsky, E. B.; Coates, G. W. J. Am. Chem. Soc. 2001, 123, 3229-3238; Bovey, F. A.; Mirau, P. A. NMR of Polymers; Academic Press, San Diego, 1996.)

$$[ mmr ] = \frac{{P}_{r} {P}_{m}}{2} \\ [ rmr ] = \frac{{P}_{r}^{2}}{2}$$

where
Pₘ is probability of generating a meso (same) or “m” sequence when a new monomer is added to a polymer, or of finding a meso dyad in an existing polymer, such as observed in isotactic structures;
Pᵣ is the probability of generating a racemic (opposite) or “r” sequence when a new monomer is added to a polymer, or of finding a racemic dyad in an existing polymer, such as observed in syndiotactic structures; and
the m and r notations refer to the configuration of one pseudochiral centre relative to its neighbour, where m designates a meso dyad; and r designates a racemic dyad.

The assignment for each tetrad's chemical shift is based on the generally accepted values. (Thakur, K. A. M.; Kean, R. T.; Zell, M. T.; Padden, B. E.; Munson, E. J. Chem. Commun. 1998, 1913-1914.)

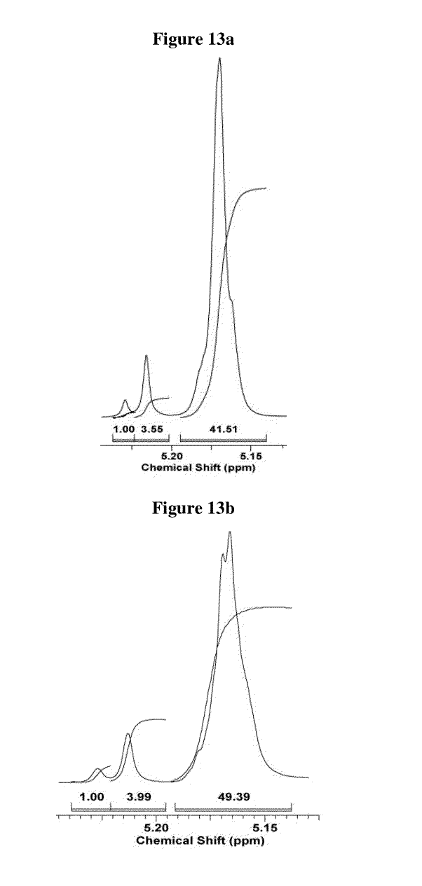

In a 20 mL scintillation vial, rac-2 (5 mg, 0.071 mmol) dissolved in 1 mL of CH₂Cl₂ and rac-lactide (0.205 g, 1.42 mmol) in 1.5 mL of CH₂Cl₂ was mixed and the total volume made to 3 mL. The reaction was allowed to proceed for 4 h after which time the reaction was quenched with a few drops of HCl in ether. A 0.5 mL sample of the reaction mixture was evaporated under vacuum for 3 hours and was dissolved in CDCl₃. ¹H{¹H} decoupled of the methine region was obtained on the a Bruker 600 MHz spectrometer. A analogous procedure was followed for the polymerization of rac-lactide with (R,R)-2. Thereafter the mixture was evaporated under vacuum and the polymer was isolated by washing 3 times with cold methanol. The isolated polymer was subsequently dried under vacuum for 4 h prior to GPC analysis. The ¹H{¹H} NMR (CDCl₃, 25° C.) spectra of methine regions for ROP of rac-LA with rac-2 at 97% conversion and (R,R)-2 (R,R-2 dimer) at 96% conversion are shown in FIGS. 13a and 13b, respectively.

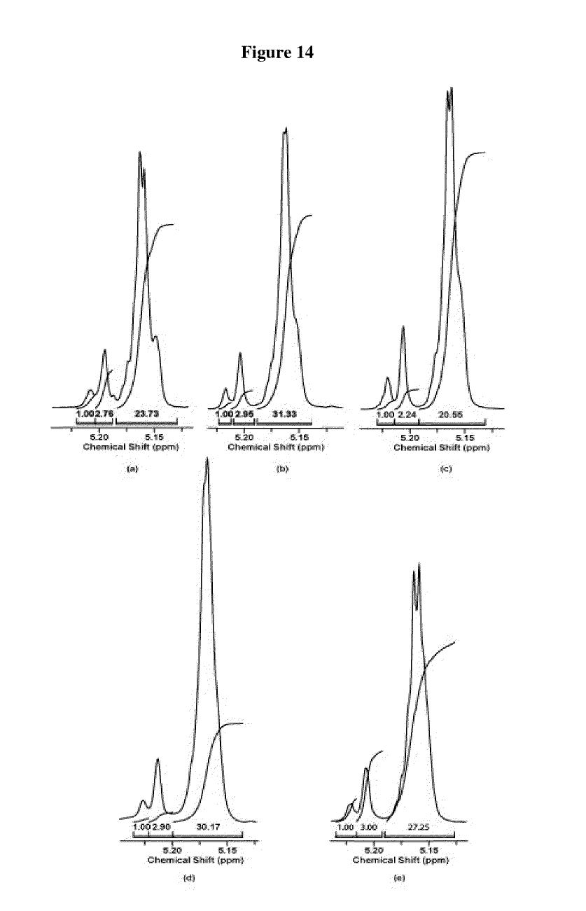

The ¹H{¹H} NMR spectra of the methine region for ROP of rac-LA with (R,R)-2 is shown in FIG. 14 after (a) 11% (b) 24% (c) 47% (d) 60% (e) 97% conversion.

### Example 7

### PLA Polymerization Rates

Rac-2 and (R,R)-2 are highly active catalysts for the ring opening polymerization of rac-LA. Reaction of rac-2 (2 mM) with 200 equivalents of rac-LA (25° C., CH₂Cl₂) results in 97% conversion in 30 min. Polymerization of up to 1000 equivalents of rac-LA with rac-2 (CH₂Cl₂) is complete in under 4 h and shows a linear relationship between Mₙ and added monomer as well generally low molecular weight distributions indicative of a controlled system.

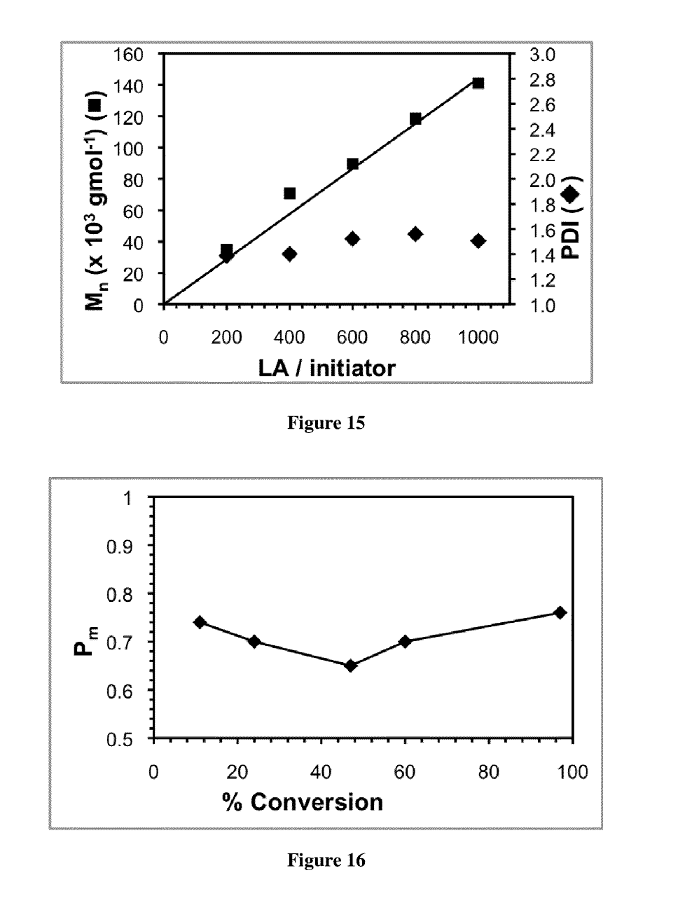

A plot of observed PLA Mₙ (ν) and molecular weight distribution (♦) as functions of added rac-LA for catalyst rac-2 is shown in FIG. 15. The line on the plot indicates the calculated Mₙ values based on the LA:initiator ratio.

The data shown demonstrates that the present catalysts are faster, by far, than the chiral aluminum salen or aluminum binap systems which show similar conversions at 70° C. in 4 d and 14 h, respectively. (Ovitt, T. M.; Coates, G. W. J. Am. Chem. Soc. 2002, 124, 1316-1326.; Zhong, Z. Y.; Dijkstra, P. J.; Feijen, J. Angew. Chem. Int. Ed. 2002, 41, 4510-4513.) The achiral aluminum salens have much faster rates depending on the ligand substitution patterns. (Nomura, N.; Ishii, R.; Akakura, M.; Aoi, K. J. Am. Chem. Soc. 2002, 124, 5938-5939.; Hormnirun, P.; Marshall, E. L.; Gibson, V. C.; Pugh, R. I.; White, A. J. P. PNAS 2006, 103, 15343-15348.) The rate of polymerization is first order in both LA and rac- or (R,R)-2 concentrations, resulting in an overall second order rate law (rate=k[catalyst][initiator]) with an overall rate constant of 0.26(0.02) mol⁻¹ s⁻¹ which is comparable to that observed for other dinuclear indium catalysts. (Douglas, A. F.; Patrick, B. O.; Mehrkhodavandi, P. Angew. Chem. Int. Ed. 2008, 47, 2290-2293.)

### Example 8

### Polymerization of Rac-Lactide for GPC Analysis

Rac-2 and (R,R)-2 are highly active for the polymerization of rac-lactide at 25° C., giving isotactic enrichment of PLAs (Pₘ=0.74-0.77). GPC analysis of the polymers indicated well controlled polymerization, with polydispersities of 1.3-1.6.

Rac-2 was reacted with 200 equivalents of rac-lactide (25° C., THF) and 97% conversion of the monomer to polymer was observed in 30 minutes when analyzed by ¹H NMR spectroscopy. The (R,R)-2 complex showed similar activity while giving a slightly higher tacticity (Pₘ=0.77).

In a 20 mL scintillation vial, complex (R,R)-2 (5 mg, 0.0710 mmol) was dissolved in 1 mL of CH₂Cl₂ and rac-lactide (0.2050 g, 1.423 mmol) in 1.5 mL of CH₂Cl₂ was mixed and the total volume made to 3 mL. The reaction was allowed to proceed for 4 hours and the reaction was quenched with a few drops of HCl in ether. Thereafter the mixture was evaporated under vacuum and the polymer was isolated by washing 3 times with cold methanol. The isolated polymer was subsequently dried under vacuum for 4 hours prior to GPC analysis.

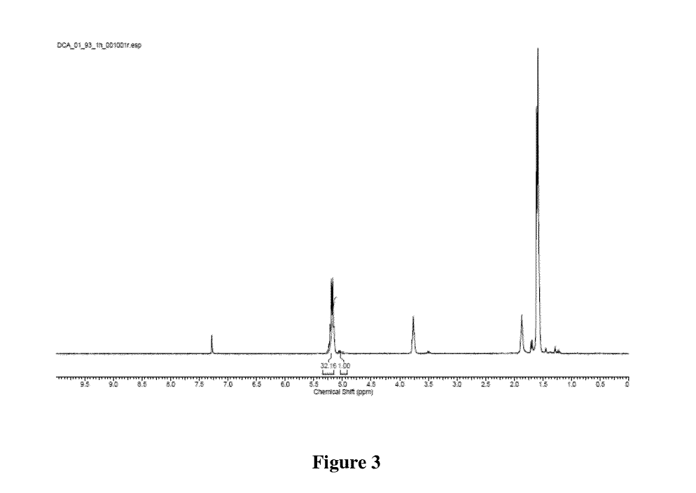

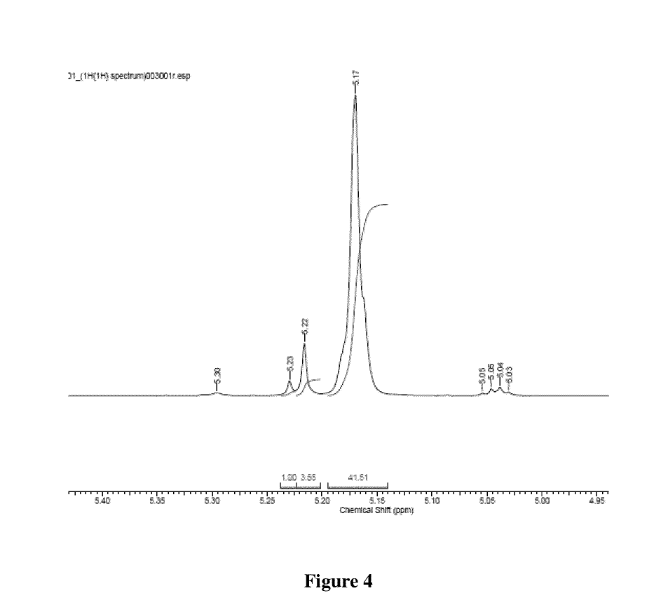

A conversion of 96% was observed in 30 minutes when 8 mg (0.0114 mmol) of the rac-2 catalyst was reacted with ˜200 equivalents of rac-lactide (0.3268 g, 2.26 mmol) in 2.5 mL of THF. ¹H NMR spectrum after 1 hour (97% conversion) of reaction time is shown in FIG. 3. The Pᵣ (0.21) and Pₘ (0.74) values for the polymerization was obtained using a ¹H{H} decoupled spectrum (600 MHz). The spectrum is shown in FIG. 4.

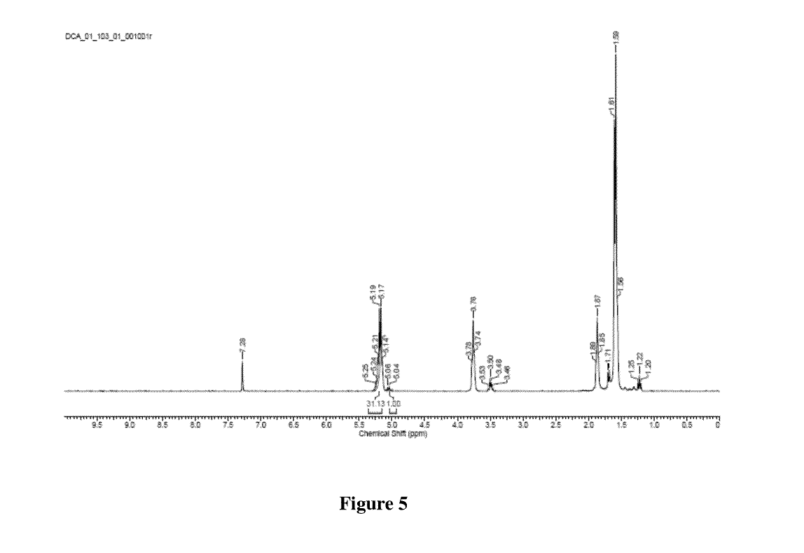

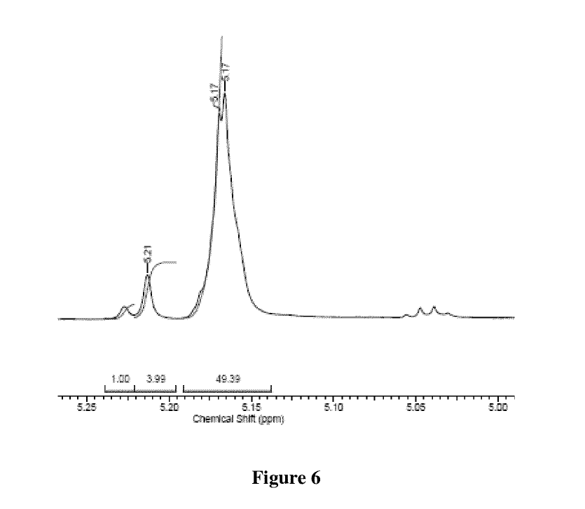

A conversion of 96% was observed after 70 minutes when 6 mg (0.00855 mmol) of the (R,R)-2 catalyst was reacted with 200 equivalents of rac-lactide (0.2452 g, 1.701 mmol) in 2.5 mL of THF. ¹H NMR spectrum after 70 minutes of reaction time is shown in FIG. 5. The ¹H{¹H} NMR spectrum of methine region after of polymerization of rac-Lactide with (R,R)-2 is shown in FIG. 6.

### Example 9

### Gel Permeation Chromatography and Characterization of Isotactically Enriched PLA

Gel permeation chromatography (GPC) analysis of the polymers resulting from the reactions of 200, 400, 600, 800, and 1000 equivalents of rac-lactide monomer with the rac-2 dimer were carried out to further understand the polymerization process. The results are shown in Table 2.

TABLE 2

| | | | | | | M_{n theo.}/ | M_{n GPC.}/^{c} | Mw./^{c} | |
|---|---|---|---|---|---|---|---|---|---|
| Entry | [LA]₀:Initiator | Solvent | Temp./° C. | Time/h | Conv. (%)^{a} | gmol⁻¹ | gmol⁻¹ | gmol⁻¹ | Mw/Mₙ^{c} |
| 1 | 200 | CH₂Cl₂ | 25 | 4 | 99 | 28512 | 34900 | 48450 | 1.387 |
| 2 | 400 | CH₂Cl₂ | 25 | 4 | 99 | 57024 | 70690 | 99060 | 1.401 |
| 3 | 600 | CH₂Cl₂ | 25 | 4 | 99 | 85536 | 89530 | 136200 | 1.522 |
| 4 | 800 | CH₂Cl₂ | 25 | 4 | 99 | 114048 | 118500 | 184900 | 1.56 |
| 5 | 1000 | CH₂Cl₂ | 25 | 4 | 99 | 142560 | 141100 | 212450 | 1.506 |

^{a}Monomer conversion was determined by ¹H NMR.
^{c}Determined by GPC using a viscositymeter, RI detector and a light scattering detector.

### Example 10

### Synthesis of Isotactic Rac-LA

All reactions were carried out at room temperature in CH₂Cl₂ and polymer samples obtained at 99% conversion.

Polymerization of rac-LA with (R,R)-2 (25° C., CH₂Cl₂) yields isotactic polymers (Pₘ=0.77, Tₘ=138° C.) as determined by ¹H{¹H} NMR spectroscopy. Polymerization of rac-LA with rac-2 yields polymers with slightly lower Pₘ values of 0.74 and similar melting points (Tₘ=141° C.) (see SI). To further probe the mechanism of selectivity the rates of polymerization of rac-, D-, and L-lactide with rac- and (R,R)-2 were determined (Table 3). There is a five-fold difference in the rate of polymerization of L- and D-lactide with (R,R)-2 (Table 3, entries 1 and 2) The k_{obs} value for ROP of rac-LA with (R,R)-2 is identical to that of D-LA, indicating that polymerization is significantly hampered by the presence of D-LA. The k_{obs} values for polymerizations with rac-2 are roughly the same, as expected. The k_{L-LA}/k_{D-LA} value of 5 for (R,R)-2 is lower than the less active aluminum-salen systems (k_{L-LA}/k_{D-LA}˜14),¹⁴ but is nonetheless significant and supports site control as the major contributor to selectivity.

All reactions were carried out with 200 equiv of LA in CD₂Cl₂ at 25° C. and followed to 90% conversion by ¹H NMR spectroscopy. ^{a} [catalyst]=0.0023 M, ^{b} [LA]=0.45 M. Table 3 below shows the difference in rate of polymerization of rac-lactide, D-lactide, and L-lactide with rac-2 or (R,R)-2.

TABLE 3

| | | | K_{obs} |
|---|---|---|---|
| Entry | Catalyst^{a} | Monomer^{b} | (×10⁻⁴ s⁻¹) |
| 1 | (R,R)-2 | D-LA | 4.3 |
| 2 | (R,R)-2 | L-LA | 22 |
| 3 | (R,R)-2 | rac-LA | 4.6 |
| 4 | rac-2 | rac-LA | 23 |
| 5 | rac-2 | D-LA | 22 |
| 6 | rac-2 | L-LA | 26 |

During the polymerization of rac-LA with (R,R)-2, the tacticity of the polymer varies in a narrow range (Pₘ=0.77˜0.65) with conversion. The plot of Pₘ vs. conversion shows the highest Pₘ values at <20% and >95% conversion (˜0.75), and the lowest value at 50% conversion (˜0.65) (FIG. 16). In a site selective catalyst such as (R,R)-2 the preferred monomer (L-LA) is consumed initially, leading to an L-enriched polymer chain with a high Pₘ value. As L-LA is depleted, more D-LA is incorporated and the Pₘ value is lowered. At higher conversions the concentration of L-LA is depleted and thus the polymer is composed of predominantly D-LA, thus the Pₘ values increase. This is a clear indication of formation of a stereoblock polymer. These results can bees seen in FIG. 16, which shows a Plot of Pₘ vs. conversion for polymerization of rac-LA with (R,R)-2.

The chiral indium catalyst (R,R)-2 shows a remarkable combination of high activity and isoselectivity for the polymerization of rac-lactide. Based on preliminary kinetics studies this system clearly shows a high degree of enatiomorphic site control based on ligand chirality.

### Example 11

### Water Reactivity

In a Schlenk flask 20 mg (0.028 mmol) of the (R,R)-2 complex was dissolved in THF.

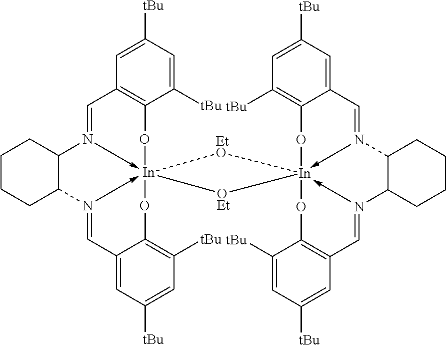

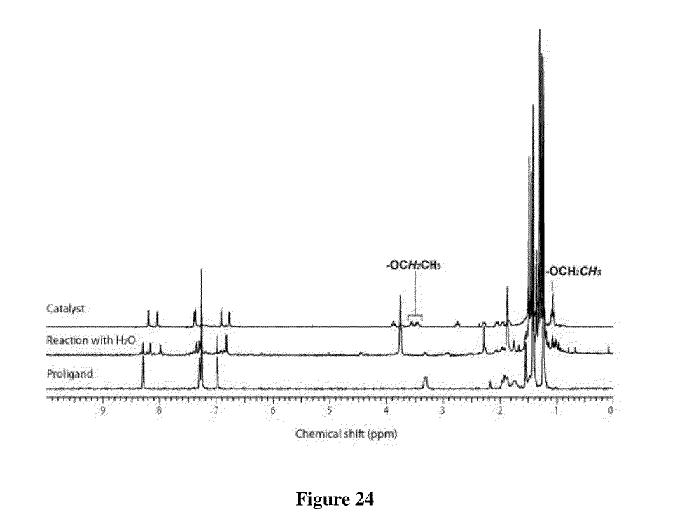

To this solution 2.5 μL (0.138 mmol) of water dissolved in dry THF was added. This reaction was allowed to stir overnight. Subsequently the volatile components were evaporated under vacuum to afford a yellow residue. ¹H NMR analysis indicated the formation of a (salen)InOH or (salenOH)₂ species with some ligand impurities (FIG. 24). ¹H NMR (400.19 MHz, CDCl₃): δ 8.16 (1H, s, N═CH), 7.36 (1H, s, N═CH), 7.20-7.31 (2H, ArH), 6.81-6.82 (2H, s, ArH), 4.40-4.50 (1H, m, —CH— of DACH 2.88-2.95 (1H, m, —CH— of DACH), 2.30-1.01 (8H, m, —CH₂— of DACH), 1.53-1.20 (18H Ar—C(CH₃)₃)

The obtained ¹H NMR spectrum indicated two main products from the reaction, one being the proligand. The other two imine and aryl protons in the spectrum had shifted slightly up-field compared to the catalyst and showed the complete disappearance of the ethoxide protons. This is preliminary evidence to suggest the formation of the (salen-InOH)₂ complex. It is also noteworthy that with a large excess of water (≧20 equivalents) only the proligand was observed in the ¹H NMR spectrum.

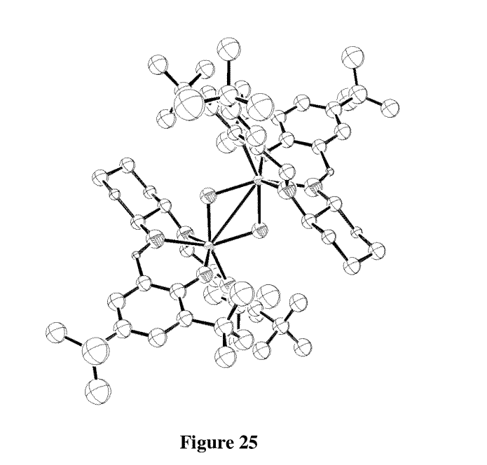

Furthermore X-ray crystallographic analysis of crystals obtained from a catalyst mixture exposed to water (grown from hexanes at ambient temperature) indicated the formation of a dimeric bis-hydroxy complex (FIG. 25).

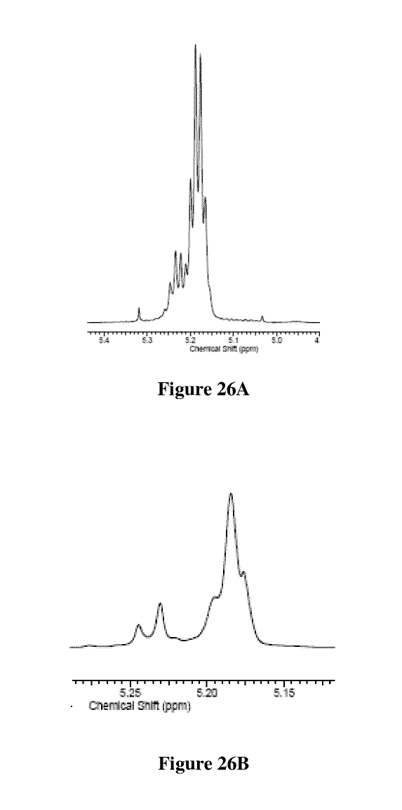

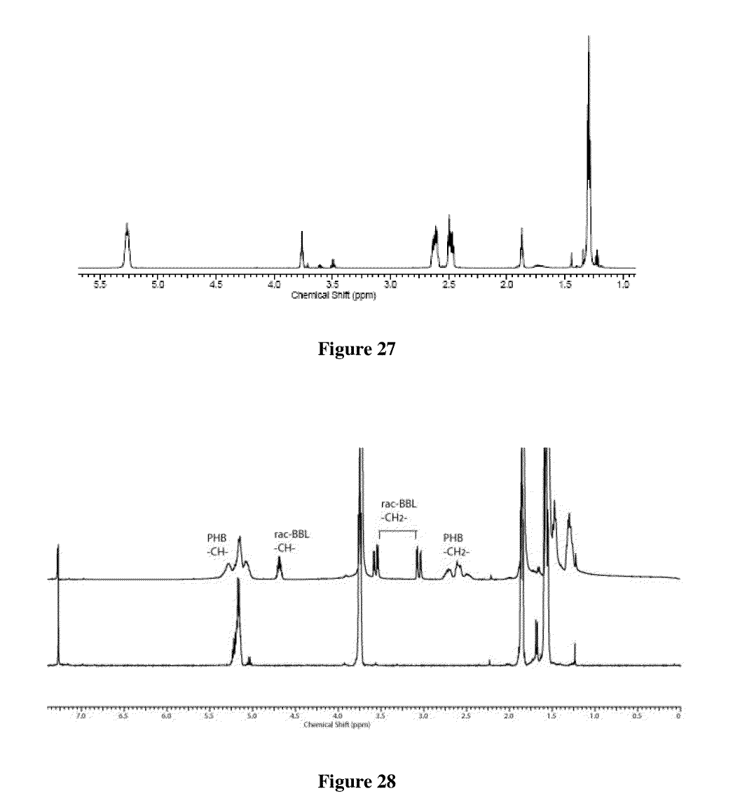

The mixture was used to successfully polymerize 198 mg (1.35 mmol) of rac-LA in 2 mL in CH₂Cl₂. The polymerization reached >98% in under 4 hours. ¹H{¹H} NMR analysis indicated a Pₘ value of 0.72. See FIGS. 26A and 26B.

### Example 12

### Immortal Polymerization with SalenInOEt Catalysts

In a 20 mL scintillation vial 9.2 mg (0.015 mmol) of (R,R)—N,N′-Bis(3-methyl-5-tert-butyl-salicylidene)-1,2-cyclohexanediamino indium ethoxide was dissolved in 1 mL CH₂Cl₂ to which was added 10 μL of a stock solution of isopropanol (0.015 mmol) prepared by dissolving 110 μL of isopropanol in 1.00 mL of CH₂Cl₂. This solution was added to a stirring solution of rac-lactide (0.427 g, 2.98 mmol) in 2 mL of CH₂Cl₂ and allowed to stir at room temperature for 16 hours. A control was setup under the same conditions without the isopropanol. The resulting polymers were isolated by precipitating from cold methanol and dried under vacuum prior to molecular weight analysis by gel permeation chromatography in THF.

The results of the immortal polymerization are provided in the table below.

| | Rac-LA/catalyst/ | Mn(Theoretical) | Mn(Experimental) | |
|---|---|---|---|---|
| Entry | iPrOH (mol) | g/mol | g/mol | PDI |
| 1 | 200/1/0 | 28826 | 25580 | 1.29 |
| 2 | 200/1/1 | 14413 | 17180 | 1.57 |

### Example 13

### Polymerization of β-butyrolactone (BBL)

In a 20 mL scintillation vial 5 mg (0.0071 mmol) of (R,R)—N,N′-Bis(3,5-di-tert-butylsalicylidene)-1,2 cyclohexanediamine indium ethoxide was dissolved in 2 mL of THF. To this solution 120 μL (1.47 mmol) of rac-β-butyrolactone was added and allowed to stir for 8 hours. The ¹H NMR spectrum of the reaction confirmed the polymerization of BBL to form poly (hydroxy buyrate) (PHB) (FIG. 27)

### Example 14

### Synthesis of PLA/PHB Blockcopolymers

In a 20 mL scintillation vial 5 mg (0.0071 mmol) of (R,R)—N,N′-Bis(3,5-di-tert-butylsalicylidene)-1,2-cyclohexanediamino indium ethoxide was dissolved in 1 mL of THF. This was added to a stirring solution of rac-LA (0.205 g, 1.43 mmol) in 1 mL of THF. The reaction was allowed to run overnight and the monomer conversion was determined by ¹H NMR spectroscopy. Then to this solution 120 μL (1.47 mmol) of rac-β-butyrolactone (“rac-BBL”) was added and allowed to stir overnight. The ¹H NMR spectrum of the reaction shows that though full conversion was not achieved, the polymer PLA chain ends are still active at the end of the polymerization of LA and continues to polymerize rac-BBL. This supports the formation of PLA/PHB diblock copolymers.

FIG. 28 shows the ¹H NMR spectrum of the product of the rac-LA polymerization overlaid with the ¹H NMR spectrum of the product following addition of the rac-BBL.

### Example 15

### Polymerization Using PEG 350 as Chain-Transfer Agent (CTA)

In a 20 mL scintillation vial 5 mg (0.0081 mmol) of (R,R)—N,N′-Bis(3-methyl-5-tert-butyl-salicylidene)-1,2-cyclohexanediamino indium ethoxide was dissolved in 1 mL CH₂Cl₂ to which was added 2.6 μL poly(ethylene glycol) with an average molecular weight of 350 g/mol (PEG 350). A solution of 580 mg (4 mmol) of rac-LA in 2 mL of CH₂Cl₂ was prepared and added to this mixture. After being stirred overnight, the reaction was quenched using a solution of HCl in diethyl ether and the polymer was isolated using by adding cold methanol. The polymer was washed 3 times with methanol and dried under vacuum for 8 hours. GPC analysis on the polymer was carried out in THF.

| | Rac-LA/catalyst/ | Mn(Theoretical) | Mn(Experimental) | |
|---|---|---|---|---|
| Entry | PEG-350 (mol) | g/mol | g/mol | PDI |
| 1 | 500/1/1 | 35089 | 21130 | 1.43 |

### Example 16

### Polymerization Using Benzyl Alcohol as Chain-Transfer Agent (CTA)

98%+ L lactide (0.4 g, 2.78 mmol) was weighed into a small vial and dissolved in 2 mL CH₂Cl₂ to give a colourless solution. (R,R)—N,N′-Bis(3,5-di-tert-butylsalicylidene)-1,2-cyclohexanediamino indium ethoxide (0.02 g, 0.014 mmol) was also weighed into a separate small vial and dissolved in 1 mL CH₂Cl₂ to give a yellow solution. Benzyl alcohol (0.003 g, 0.028 mmol) was weighed into another small vial and dissolved in 1 mL CH₂Cl₂ to give a colourless solution. The catalyst solution and benzyl alcohol solution were added to the lactide solution. Two 0.5 mL portions of CH₂Cl₂ were each used to rinse the vials that had contained indium catalyst and benzyl alcohol and were combined with the reaction mixture. After stirring at room temperature for 1 hour, an aliquot was removed from the reaction mixture and added to an NMR tube. CDCl₃ was added and the ¹H NMR spectrum recorded indicating that monomer conversion had reached 95%. At this point, 2-3 drops of HCl solution were added to terminate the reaction and stirred for 15 minutes.

The reaction solution was then added dropwise to 150 mL of rapidly stirred methanol at −30° C. giving precipitated PLA as a white powder. The polymer was isolated by filtration using a Büchner funnel and a water aspirator. 2×25 mL portions of methanol were used to wash the polymer on the filter paper. The polymer was further dried under vacuum at room temperature for 16 hours. ¹H NMR spectra of PLA product was: δ 1.56 (3H, d, CH₃), 5.14 (1H, q, CH). The molecular weights of the produced PLA are provided in Table 4 below.

TABLE 4
Molecular Weight of PLA Produced with Chain Transfer Agent

| | | Mₙ | Mₙ | M_{w} |
|---|---|---|---|---|
| | M/I/Chain | (Theoretical) | (Experimental) | (Experimental) |
| Entry | Transfer | (g/mol) | (g/mol) | (g/mol) |
| 1 | 200/1/0 | 28800 | 22,000 | 31,200 |
| 2 | 200/1/2 | 9,600 | 10,000 | 15,000 |

### Example 17

### Polymerization of Lactide using (R,R)—N,N′-Bis(3,5-di-tert-butylsalicylidene)-1,2-cyclohexanediamino indium ethoxide

1. General Considerations

NMR spectra were recorded on a Varian 400 MHz spectrometer. ¹H NMR chemical shifts are reported in ppm versus residual protons in deuterated chloroform (CDCl₃) at δ=7.24. Molecular weights (Mₙ, M_{w}) were determined by Gel Permeation Chromatography (GPC), on a Varian PL-GPC 50 Plus instrument using various molecular weight polystyrene samples as calibration standards. GPC samples were dissolved in THF with a concentration of approximate 3 mg/mL. The solution was stirred overnight and then filtered using a 0.2 μm PTFE syringe filter. Melting transition temperature (Tₘ) and crystallization temperature (T_{c} were determined by Differential Scanning Calorimetry (DSC), on a TA DSC Q1000 instrument. Samples were annealed at 130° C. for 4 hours and cooled to room temperature before analysis. The experiment was carried out under N₂ atmosphere with heat rate of 10° C./min from 40° C. to 200° C.

All polymerization reactions were carried out under an inert atmosphere either in a glove box or using standard Schlenk line techniques.

2. Materials

Two lactide starting materials with either 98%+ or 96%+ of the L-lactide isomer were used as received from NatureWorks LLC. Anhydrous dichloromethane (DCM) was collected from a solvent purification system and degassed via three successive freeze-pump-thaw cycles. 4M HCl solution in dioxane, tin(II) 2-ethylhexanoate and benzyl alcohol were purchased from Sigma Aldrich and used as received. Methanol was purchased from Fisher and used as received.

3. Indium-Catalyzed Polylactide (PLA) Preparation

Bulk (e.g. Melt) Polymerization

Bulk polymerization studies involving both 98%+ and 96%+ L lactide were conducted using various temperatures: 110° C., 130° C., 160° C., and 190° C. All reactions were performed using an identical procedure. The reaction at 110° C. was used to present the procedure. Reactants and actual mass used were listed in Table 5.

98%+ L lactide and (R,R)—N,N′-Bis(3,5-di-tert-butylsalicylidene)-1,2-cyclohexanediamino indium ethoxide were weighed individually and added to a small mortar where they were mixed and ground together by a pestle. A pale yellow powder mixture was obtained and transferred to a 100 mL Schlenk flask equipped with a stir bar.

The flask was placed on a hotplate at 110° C. and stirred. The reactant mixture started to melt and resinified in approximately 5 minutes. The whole flask was covered with aluminum foil to prevent sublimation of lactide monomer. The reaction was allowed to proceed for 1 hour before slowly cooling to room temperature.

3 mL CH₂Cl₂ was added to the flask giving a yellow solution. 2-3 drops of HCl solution were added to terminate the polymerization and allowed to stir for 15 minutes. The solution was then added dropwise to 100 mL of rapidly stirred methanol at −30° C. giving precipitated PLA as white fibres. The polymer was isolated by filtration using a Büchner funnel and a water aspirator. 2×25 mL portions of methanol were used to wash the PLA on the filter paper. The PLA was further dried under vacuum at room temperature for 16 hours. ¹H NMR spectra of PLA product in all cases was: δ 1.56 (3H, d, CH₃), 5.14 (1H, q, CH).

TABLE 5
Reactants Mass Used in bulk Polymerization by (R,R)-N,N′-Bis(3,5-
di-tert-butylsalicylidene)-1,2-cyclohexanediamino indium ethoxide

| | Monomer: | Mass of | Mass of |
|---|---|---|---|
| Lactide | Catalyst | Lactide | Indium Catalyst |
| 98% + L lactide | 200:1 | 0.2 g | 9.78 mg (6.94 μmol) |
| 98% + L lactide | 1000:1 | (1.39 mmol) | 1.96 mg (1.39 μmol) |
| 96% + L lactide | 200:1 | | 9.78 mg (6.94 μmol) |

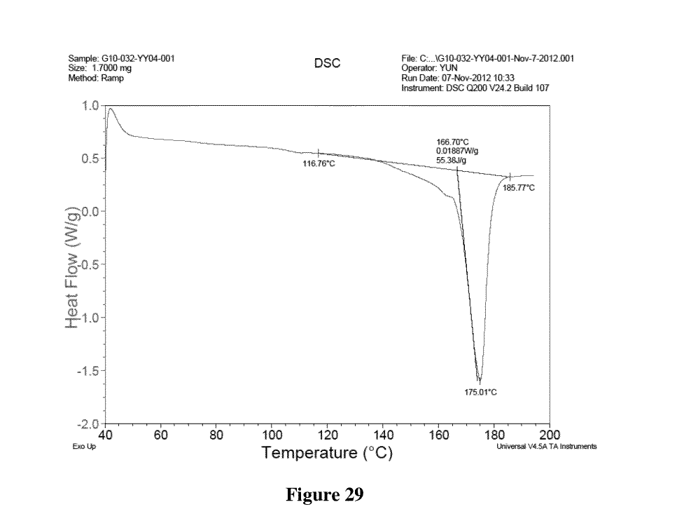

The test data are summarized in Table 6 and the DSC trace of the PLA product is shown in FIG. 29.

TABLE 6
Polylactide Properties from bulk Polymerization by Indium Catalyst

| | | | | | | Lactide | |
|---|---|---|---|---|---|---|---|
| Lactide | T(reaction) | M:I* | Mₙ (g/mol) | M_{w} (g/mol) | Tₘ | Conversion | Yield |
| 98% + L lactide | 110° C. | 200:1 | 20,100 | 29,900 | 175° C. | 96% | 83% |
| 96% + L lactide | | | 22,200 | 37,500 | 174° C. | 91% | 75% |
| 98% + L lactide | 130° C. | | 18,800 | 30,500 | 174° C. | 98% | 84% |
| 96% + L lactide | | | 29,300 | 66,600 | 170° C. | 100% | 80% |
| 98% + L lactide | 160° C. | | 25,600 | 47,300 | 173° C. | 93% | 66% |
| 96% + L lactide | | | 23,200 | 54,400 | 168° C. | 94% | 66% |
| 98% + L lactide | 190° C. | | 12,800 | 22,000 | 164° C. | 80% | 46% |
| 96% + L lactide | | | 12,900 | 21,200 | 155° C. | 80% | 46% |
| 98% + L lactide | 110° C. | 1000:1 | 40,100 | 64,900 | n/a | n/a | 57% |

*-M:I indicating the ratio of lactide to (R,R)-N,N′-Bis(3,5-di-tert-butylsalicylidene)-1,2-cyclohexanediamino indium ethoxide

Solution Polymerization

Smaller Scale PLA Preparation

Solution reactions were carried out at relatively smaller scales using (R,R)—N,N′-Bis(3,5-di-tert-butylsalicylidene)-1,2-cyclohexanediamino indium ethoxide with 98%+ and 96%+ L lactide feedstocks at room temperature. All reactants and actual mass used are listed in Table 7.

98%+ L lactide was weighed into a small vial and dissolved in 1 mL DCM to give a colourless solution. (R,R)—N,N′-Bis(3,5-di-tert-butylsalicylidene)-1,2-cyclohexanediamino indium ethoxide was also weighed into a separate small vial and dissolved in 1 mL DCM to give a yellow solution. The catalyst solution was added to the lactide solution. 2×0.5 mL portions of DCM were used to rinse the vial that had contained indium catalyst and then added to the lactide solution. The reaction was stirred at room temperature for 0.5 hour or 4 hours depending on the lactide:catalyst ratio employed (see Table 7).

2-3 drops of HCl solution were added to terminate the reaction and stirred for 15 minutes. The solution was then added dropwise to 100 mL of rapidly stirred methanol at −30° C. giving precipitated PLA as white fibres. The polymer was isolated by filtration using a Büchner funnel and a water aspirator. 2×25 mL portions of methanol were used to wash the PLA on the filter paper. The PLA was further dried under vacuum at room temperature for 16 hours. ¹H NMR spectra of PLA product in all cases was: δ 1.56 (3H, d, CH₃), 5.14 (1H, q, CH).

TABLE 7
Reactants Mass Used in Solution Polymerization
by (R,R)-N,N′-Bis(3,5-di-tert-butylsalicylidene)-
1,2-cyclohexanediamino indium ethoxide

| | Lactide: | Mass of | Mass of |
|---|---|---|---|
| Lactide | Catalyst | Lactide | Indium Catalyst |
| 98% + L lactide | 200:1 | 0.2 | 9.78 mg (6.94 μmol) |
| 98% + L lactide | 700:1 | (1.39 mmol) | 2.79 mg (1.98 μmol) |
| 96% + L lactide | 200:1 | | 9.78 mg (6.94 μmol) |

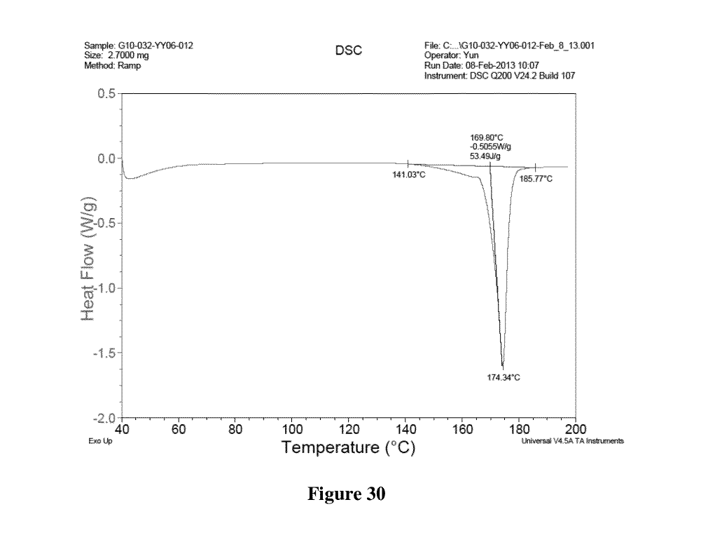

The test data are summarized in Table 8 and the DSC trace of the PLA product is shown in FIG. 30.

TABLE 8
Polylactide Properties from Solution Polymerization by Indium Catalyst

| | | | Mₙ | M_{w} | | Lactide | |
|---|---|---|---|---|---|---|---|
| Lactide | M:I | Reaction Time | (g/mol) | (g/mol) | Tₘ | Conversion | Yield |
| 98% + L lactide | 200:1 | 0.5 hour | 22,000 | 31,200 | 173° C. | 98% | 79% |
| 98% + L lactide | 700:1 | 4 hours | 33,800 | 40,500 | 174° C. | 97% | 82% |
| 98% + L lactide | 1000:1 | 4 hours | 75,700 | 78,000 (7%)* | 175° C. | 98% | 64% |
| | | | 28,700 | 31,900 (93%)* | | | |
| 96% + L lactide | 200:1 | 0.5 hour | 19,100 | 28,700/1.50 | 169° C. | n/a | 75% |

Note:
*-The percentage represents the area under each peak in the gel permeation chromatogram.

Larger Scale PLA Preparation

(R,R)—N,N′-Bis(3,5-di-tert-butylsalicylidene)-1,2-cyclohexanediamino indium ethoxide (0.685 g, 0.486 mmol) was weighed into a 250 mL Schlenk flask equipped with a stir bar, and dissolved in 50 mL DCM giving a yellow solution. 98%+ L lactide (70 g, 486 mmol) was weighed into a 500 mL Schlenk flask equipped with a large stir bar, and dissolved in 350 mL DCM giving a colorless solution. The catalyst solution was added to the lactide solution via cannulation. 2×20 mL portions of DCM were used to rinse the flask that had contained the indium catalyst and transferred to the reaction flask. A pale-yellow solution was obtained and stirred at room temperature.

After 30 minutes, the solution viscosity increased noticeably. After 2 hours, an aliquot was removed from the reaction mixture and added to an NMR tube. CDCl₃ was added and the ¹H NMR spectrum recorded indicating that monomer conversion had reached 98%. At this point, HCl solution (0.971 mL, 3.89 mmol) was added to terminate the reaction.

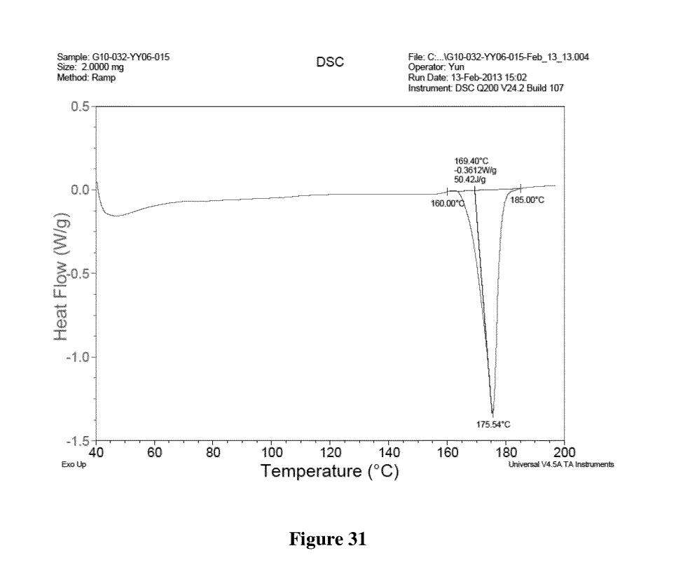

The solution was added dropwise to 5000 mL of rapidly stirred methanol at −30° C. giving precipitated PLA as white fibres. The polymer was isolated by filtration using a Büchner funnel and a water aspirator. 200 mL of methanol were used to wash the PLA on the filter paper until the filtrate was observed to be colourless. It was further dried under vacuum at room temperature for two days. ¹H NMR spectrum of PLA product was: δ 1.56 (3H, d, CH₃), 5.14 (1H, q, CH). The molecular weights of the PLA product are shown in Table 9 and the DSC trace of the PLA product is shown in FIG. 31.

TABLE 9
Molecular Weight of PLA Produced by Larger Scale Solution
Polymerization Using (R,R)-N,N′-Bis(3,5-di-tert-butylsalicylidene)-
1,2-cyclohexanediamino indium ethoxide

| | Mₙ | M_{w} | |
|---|---|---|---|
| | (g/mol) | (g/mol) | Peak Area |
| Peak 1 | 107,400 | 110,600 | 13% |
| Peak 2 | 40,600 | 45,100 | 87% |

4. Tin(II) 2-Ethylhexanoate-Catalyzed PLA Preparation

4.1 Bulk (e.g. Melt) Polymerization

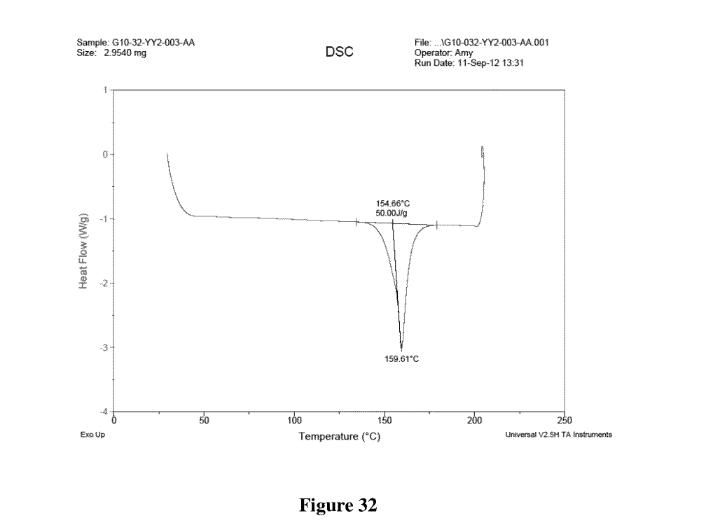

98%+ L lactide (400 mg, 2.78 mmol), tin(II) 2-ethylhexanoate (5.6 mg, 0.014 mmol) and benzyl alcohol (3 mg, 0.028 mmol) were weighed into a 25 mL Schlenk tube equipped with a small stir bar. The Schlenk tube was placed in an oil bath pre-heated to 180° C. The reactant mixture melted slowly over 30 minutes becoming a viscous white liquid. The reaction was allowed to proceed for 4 hours before slowly cooling to room temperature. 3 mL of DCM were added to the white solid giving a solution which was added dropwise to 500 mL of rapidly stirred methanol at −30° C. giving precipitated PLA as a fine white powder. This powder was separated from solvent by centrifugation at 10000 rpm for 30 minutes and dried under vacuum at room temperature. ¹H NMR spectra of PLA product in all cases was: δ 1.56 (3H, d, CH₃), 5.14 (1H, q, CH). The test data are summarized in Table 10 and the DSC trace of the PLA product is shown in FIG. 32.

TABLE 10
Polylactide Properties from Bulk Polymerization by Tin(II)
2-Ethylhexanoate

| | | | | Mₙ | M_{w} | |
|---|---|---|---|---|---|---|
| Lactide | M:I | T(reaction) | Tₘ | (g/mol) | (g/mol) | Yield |
| 98% + L lactide | 200:1 | 180° C. | 160° C. | 7,300 | 11,200 | 61% |
| 96% + L lactide | | | 146° C. | 7,500 | 11,400 | 75% |

4.2 Solution Polymerization

98%+ L lactide (200 mg, 1.39 mmol) was weighed into a 25 mL Schlenk tube equipped with a stir bar. Tin(II) 2-ethylhexanoate (2.8 mg, 6.94 μmol) and benzyl alcohol (1.5 mg, 0.014 mmol) were weighed into a small vial and dissolved in 1 mL of toluene giving a colorless solution. This solution was transferred to the tube containing lactide and the small vial was rinsed with 2×1 mL portions of toluene and transferred to the lactide solution. The Schlenk tube was then fitted with a small condenser under an N₂ purge. The tube was immersed in an oil bath at 95° C. and allowed to react for 16 hours.

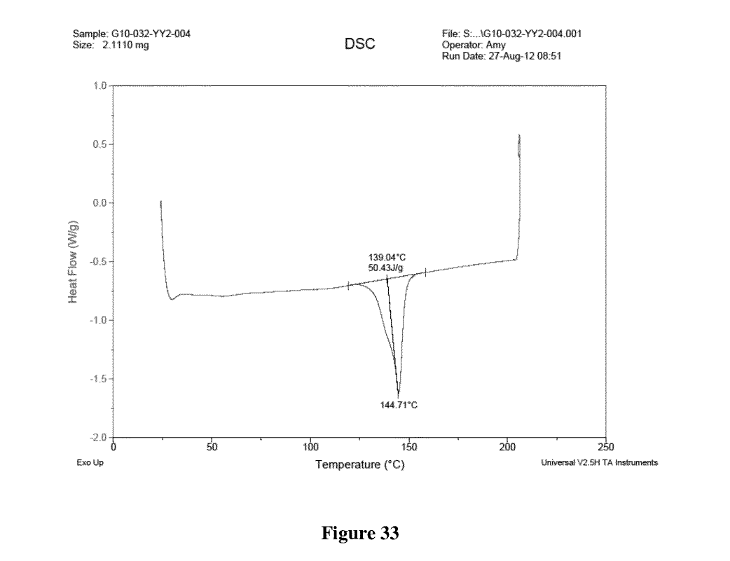

The reaction was allowed to slowly cool to room temperature, and then 2-3 drops of HCl solution were added to terminate the reaction. The solution was then added dropwise to 500 mL of rapidly stirred methanol at −30° C. giving precipitated PLA as a fine white powder. This powder was separated from solvent by centrifugation at 10000 rpm for 30 minutes and dried under vacuum at room temperature. ¹H NMR spectra of PLA product in all cases was: δ 1.56 (3H, d, CH₃), 5.14 (1H, q, CH). The test data are summarized in Table 11 and the DSC trace of the PLA product is shown in FIG. 33.

TABLE 11
Polylactide Properties from Solution Polymerization by Tin(II)
2-Ethylhexanoate

| | | | Mₙ | M_{w} | | |
|---|---|---|---|---|---|---|
| Lactide | M:I | T(reaction) | (g/mol) | (g/mol) | Tₘ* | Yield |
| 98% + L lactide | 200:1 | 95° C. | 3,800 | 4,400 | 145° C. | 75% |
| 96% + L lactide | | | 4,800 | 5,600 | 145° C. | 75% |

Note:
*-DSC analysis was carried out without annealing the polymer at 130° C. for 4 hours.

Lactide/Polylactide/(R,R)—N,N′-Bis(3,5-di-tert-butylsalicylidene)-1,2-cyclohexanediamino indium ethoxide Solubility Test

Solubility tests of 98%+ L lactide, polylactide and (R,R)—N,N′-Bis(3,5-di-tert-butylsalicylidene)-1,2-cyclohexanediamino indium ethoxide were carried out in several common solvents.

All tests were carried out by mixing either 1 g lactide or 0.01 g polylactide with 1 mL of a given solvent in a small vial equipped with a stir bar. The mixture was stirred overnight. The solubility was verified by whether a clear solution formed or not. The results are listed in Table 12.

Upon establishing a 1:1 by volume toluene/diglyme mixture as a good solvent for both lactide and polylactide, 0.01 g (R,R)—N,N′-Bis(3,5-di-tert-butylsalicylidene)-1,2-cyclohexanediamino indium ethoxide was also found to dissolve in this mixture.

TABLE 12
Solubility Test Results

| | | | Indium |
|---|---|---|---|
| Solvent | 98% L Lactide | Polylactide | Catalyst |
| Heptane | No | No | Not tested |
| Cyclohexane | No | No | Not tested |
| Petroleum Ether | No | No | Not tested |
| Toluene | Partially | Partially | Not tested |
| | dissolved | dissolved | |
| Kerosene | No | No | Not tested |
| Diglyme | Dissolved | No | Not tested |
| Toluene/Diglyme | Dissolved | Dissolved | Dissolved |
| (1:1 by volume) | | | |

### Example 18

### Comparison of PLA Crystallizations

In this example, PLA was prepared using (R,R)—N,N′-Bis(3,5-di-tert-butylsalicylidene)-1,2-cyclohexanediamino indium ethoxide and tin(II) 2-ethylhexanoate in order to compare the PLA products prepared using the two different catalysts.

PLA was prepared as described above in Example 17. DSC analysis was then carried out without annealing the polymer at 130° C. for 4 hours. The tests were performed on a TA DSC Q 1000 instrument. Samples were heated at a rate of 10° C./min from 40° C.˜210° C. and then held isothermally for 3 minutes before cooled to 40° C. at a rate of 10° C./min. The results are shown in Table 13.

TABLE 13
PLA Crystallization Results Summary Using (R,R)-N,N′-Bis(3,5-di-tert-
butylsalicylidene)-1,2-cyclohexanediamino Indium Ethoxide and Tin(II) 2-ethylhexanoate

| Lactide | Catalyst | Polymerization | Mₙ | M_{w} | T_{c} | ΔH_{c} |
|---|---|---|---|---|---|---|
| 98% L | Indium | Solution reaction at room | 22,000 | 31,200 | 102° C. | 39.85 J/g |
| Lactide | Catalyst | temperature | | | | |
| 98% L | | Melt reaction at 110° C. | 20,100 | 29,900 | 108° C. | 41.22 J/g |
| Lactide | | | | | | |
| 98% L | Tin | Solution reaction at 95° C. | 3,800 | 4,400 | 92° C. | 26.18 J/g |
| Lactide | Catalyst | | | | | |
| 98% L | | Melt reaction at 180° C. | 7,300 | 11,200 | 90° C. | 19.06 J/g |
| Lactide | | | | | | |

The crystallization study was performed in order to examine the degree of crystallinity of the produced PLA. It is generally accepted that a value of 93.1 J/g is the heat of crystallization for a 100% crystalline PLLA or PLDA polymer (Ahmed, J. J. Thermal Anal. Calorim. 95 (3), 957-964 (2009)). Thus, the highest heat of crystallization possible is 93.1 J/g and the values obtained for heat of crystallization are commonly used as an indicator of the degree of crystallinity in addition to the crystallization temperatures themselves where higher temperatures indicate a more crystalline material. As shown in Table 13, the PLA produced using the indium catalyst had a significantly higher degree of crystallinity than the PLA produced with the tin catalyst.

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1.-27. (canceled)

28. A complex having the structure of formula (Ia) or the corresponding dimer of formula (Ib): 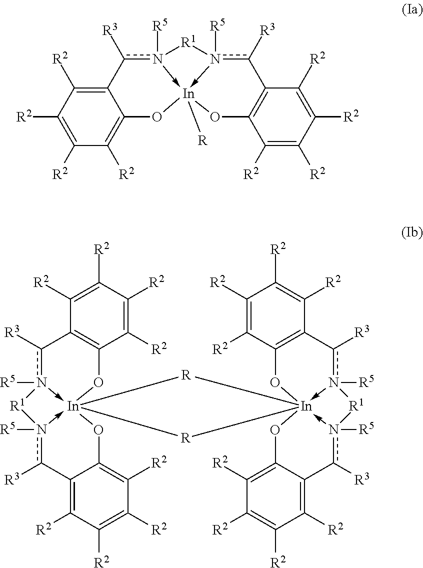
wherein
the dashed line represents an optional double bond;
each R¹ is independently an optionally substituted methylene, ethylene, butylene or pentylene, 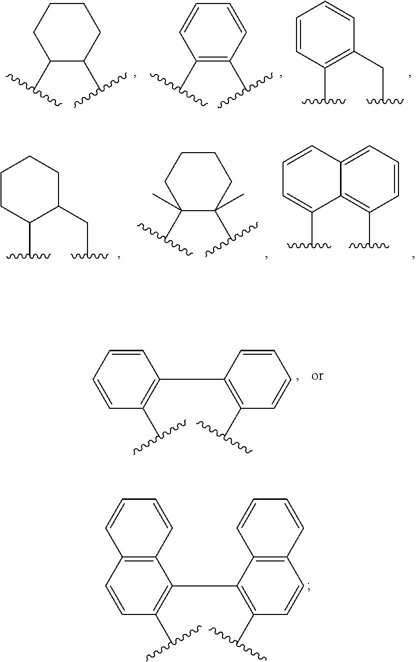
each R² is independently hydrogen, halogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl), optionally substituted aryl or SiR′₃, where each R′ is alkyl or aryl;
each R³ is hydrogen or optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl);
each R is independently OR⁴, NR⁴₂ or SR⁴; and CH₂SiR⁴₃, where each R⁴ is hydrogen, optionally substituted linear or branched C₁₋₁₈ alkyl (e.g., C₁₋₅ alkyl), such as a fluoro-substituted alkyl, or optionally substituted linear or branched (C₁₋₁₂)alkylcarbonyl (e.g., (C₁₋₅)alkylcarbonyl), such as C(O)CH₂OCH₃; and
each R⁵ is independently hydrogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl) or, when there is a C—N double bond, absent.

29. The complex of claim 28, which is 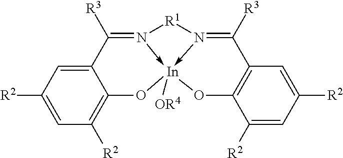
or the corresponding dimer

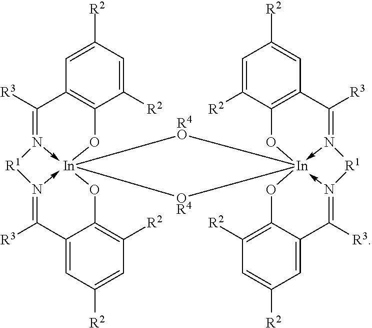

30. The complex of claim 28, wherein R¹ is

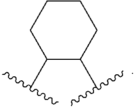 [SMILES: *C1CCCCC1*]

31. The complex of claim 28, wherein at least one R² is an optionally substituted C₁₋₅ alkyl, an optionally substituted aryl, an optionally substituted C₃-C₁₂ cyclic alkyl, or Si(aryl)₃; R³ is H and R⁴ is C₁₋₃ alkyl. each R² is H, C₁₋₅ alkyl, R³ is H and R⁴ is C₁₋₃ alkyl.

32. The complex of claim 28, wherein R¹ is chiral and enantiomerically enriched, or wherein R¹ is chiral and racemic or wherein R¹ is achiral.

33. complex of claim 32, wherein the stereochemistry of R¹ is (R,R).

34. The complex of claim 28, having the structure

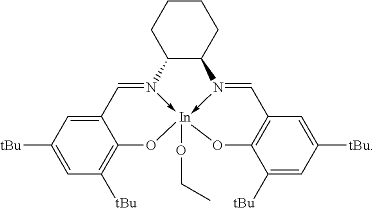

35. The complex of claim 28, comprising a ligand that is:

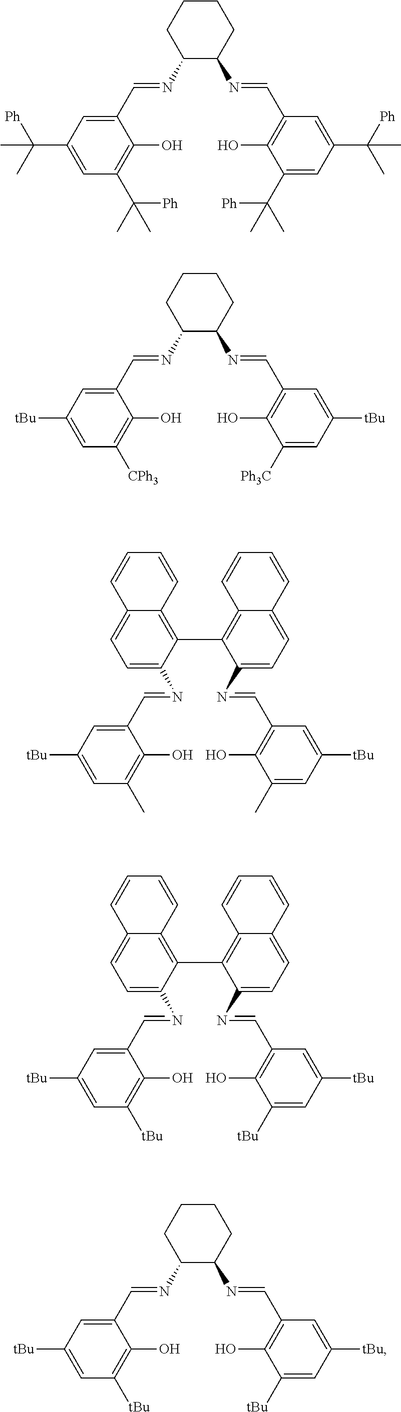

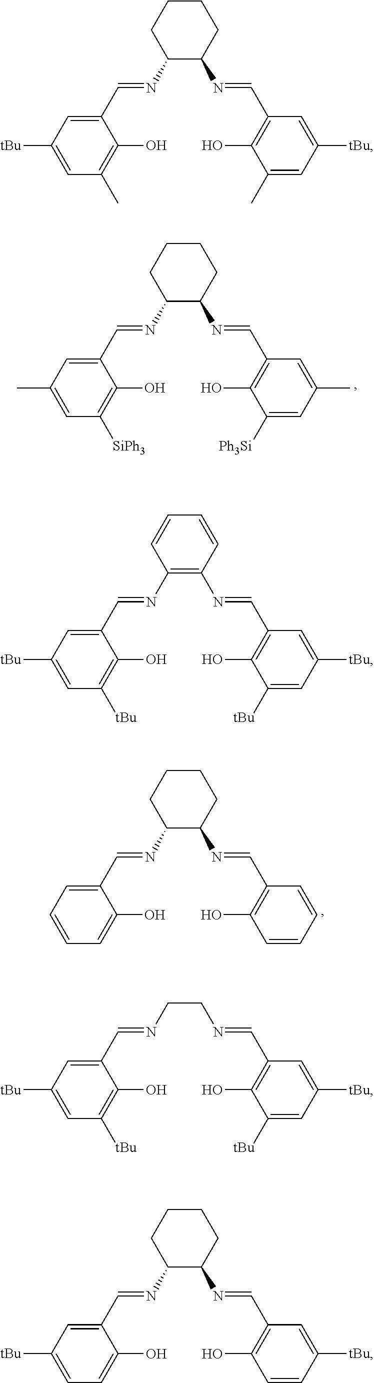

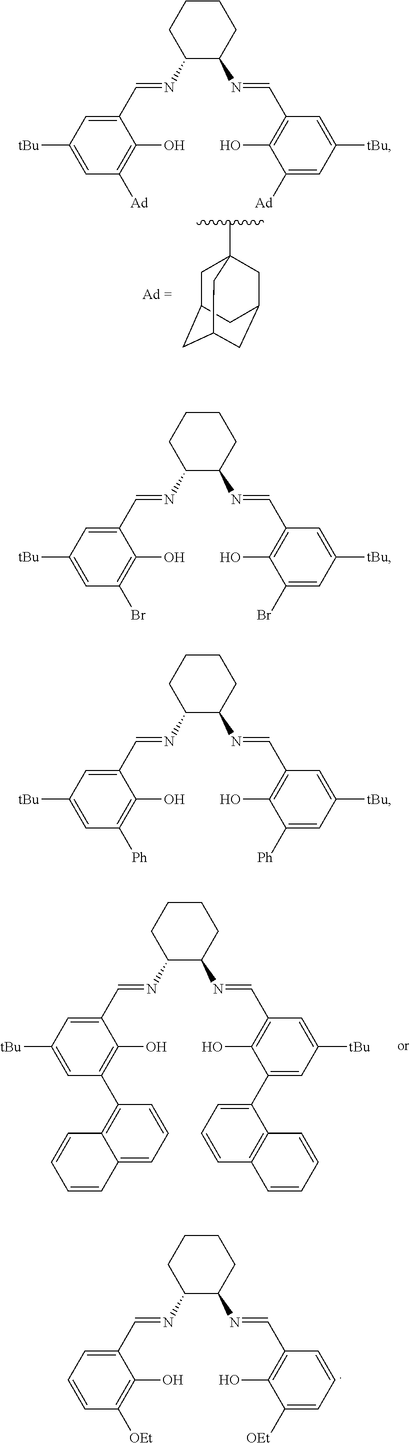

36. A method of ring-opening polymerization comprising polymerizing a cyclic ester monomer, or combination of two or more cyclic ester monomers, in the presence of a complex having the structure of formula (Ia) or the corresponding dimer of formula (Ib): 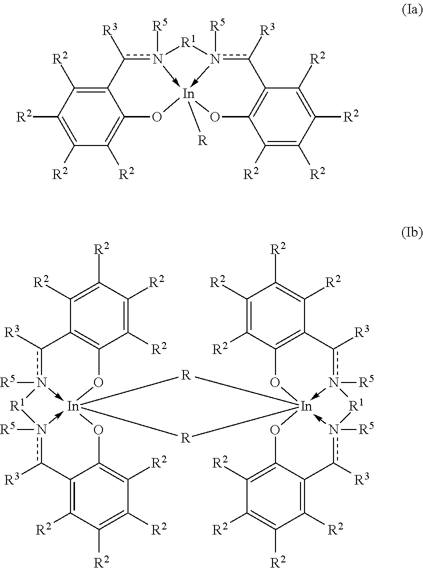
wherein
the dashed line represents an optional double bond;
each R¹ is independently an optionally substituted C₂₋₅ alkylene, 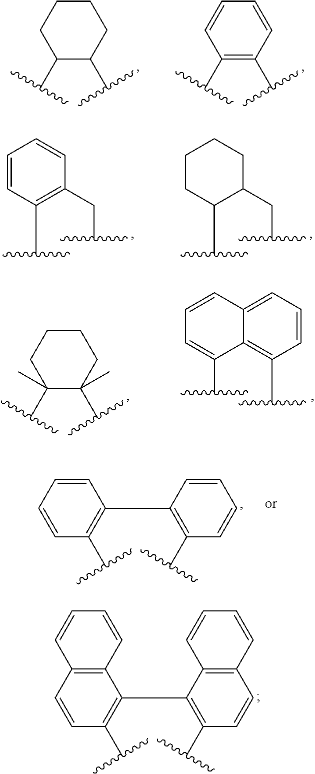
each R² is independently hydrogen, halogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl), optionally substituted aryl or SiR′₃, where each R′ is alkyl or aryl;
each R³ is hydrogen or optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl);
each R is independently OR⁴, NR⁴₂ or SR⁴; and CH₂SiR⁴₃, where each R⁴ is hydrogen, optionally substituted linear or branched C₁₋₁₈ alkyl (e.g., C₁₋₅ alkyl), such as a fluoro-substituted alkyl, or optionally substituted linear or branched (C₁₋₁₂)alkylcarbonyl (e.g., (C₁₋₅)alkylcarbonyl), such as C(O)CH₂OCH₃; and
each R⁵ is independently hydrogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl) or, when there is a C—N double bond, absent,
under conditions suitable for ring-opening polymerization.

37. The method of claim 36, wherein when a combination of two or more cyclic ester monomers are polymerized, the different monomers are polymerized simultaneously or sequentially.

38. The method of claim 36, wherein the cyclic ester monomer is a lactide and the polymerization product is a polylactic acid.

39. The method of claim 38, wherein the lactide is L-lactide, D-lactide, meso-lactide, rac-lactide, a non-equal mixture of L and D lactides, or a mixture of L, D, and meso-lactides.

40. The method of claim 38, wherein the polylactic acid is isotactically enriched.

41. The method of claim 40, wherein the isotactic enrichment is between about 0.6 and about 1.0, or between about 0.7 and about 1.0.

42. The method of claim 38, wherein the polylactic acid has a polydispersity index of less than about 2.0, or less than about 1.7, or less than about 1.5.

43. The method of claim 38, wherein the polylactic acid has a molecular weight of greater than about 300, or greater than about 10,000, or from about 300 to about 10,000,000, or from about 10,000 to about 1,000,000, or, more particularly, from about 20,000 to about 150,000, or, even more particularly, from about 28,800 to about 144,000.

44. The method of claim 36, wherein the polymerization is performed in the absence of solvent.

45. The method of claim 36, wherein the polymerization is an immortal polymerization.

46. The method of claim 36, wherein the product is a copolymer.

47. The method of claim 46, wherein the product is a random copolymer or a block copolymer.

48. A method for preparing a block copolymer, comprising:
(a) polymerizing a first cyclic ester monomer with a first complex having the structure of formula (Ia) or the corresponding dimer of formula (Ib): 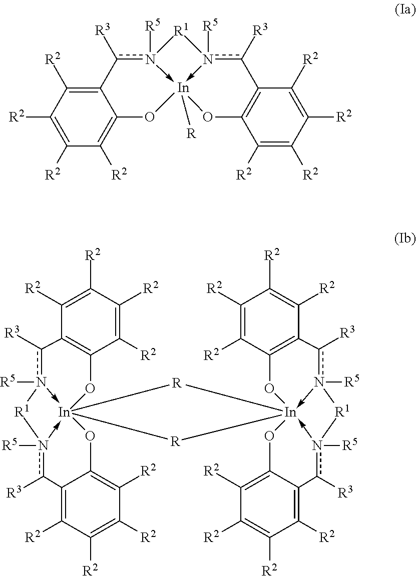
wherein
the dashed line represents an optional double bond;
each R¹ is independently an optionally substituted C₂₋₅ alkylene, 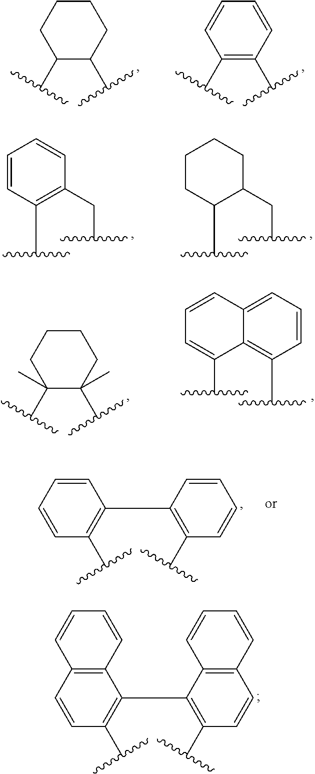
each R² is independently hydrogen, halogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl), optionally substituted aryl or SiR′₃, where each R′ is alkyl or aryl;
each R³ is hydrogen or optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl);
each R is independently OR⁴, NR⁴₂ or SR⁴; and CH₂SiR⁴₃, where each R⁴ is hydrogen, optionally substituted linear or branched C₁₋₁₈ alkyl (e.g., C₁₋₅ alkyl), such as a fluoro-substituted alkyl, or optionally substituted linear or branched (C₁₋₁₂)alkylcarbonyl (e.g., (C₁₋₅)alkylcarbonyl), such as C(O)CH₂OCH₃; and
each R⁵ is independently hydrogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl) or, when there is a C—N double bond, absent, under conditions suitable for ring-opening polymerization of the first cyclic ester monomer to form a first polymer block of the block copolymer; and
(b) polymerizing a second cyclic ester monomer, different from the first cyclic ester monomer, with a second complex of formula (Ia) or (Ib), under conditions suitable for ring-opening polymerization of the second cyclic ester monomer to form a second polymer block of the block copolymer.

49. The method of claim 48, wherein the first cyclic ester monomer is D-lactide, L-lactide, meso-lactide, rac-lactide, a non-equal mixture of L and D lactides, a mixture of L, D, and meso-lactides, β-butyrolactone, or 4-(but-3-en-1-yl)oxetan-2-one; and the second cyclic ester monomer is, lactide, D-lactide, L-lactide, meso-lactide, rac-lactide, a non-equal mixture of L and D lactides, a mixture of L, D, and meso-lactides, β-butyrolactone, or 4-(but-3-en-1-yl)oxetan-2-one.

50. The method of claim 48, additionally comprising the step of
(c) polymerizing a third cyclic ester monomer, different from the first and second cyclic ester monomer, with a third complex of formula (Ia) or (Ib) under conditions suitable for ring-opening polymerization of the third cyclic ester monomer to form a third polymer block of the block copolymer; and wherein the third complex for step (c) is the same as the first and second complexes used in steps (a) and/or (b).

51. The method of claim 50, wherein the third cyclic ester monomer is D-lactide, L-lactide, meso-lactide, rac-lactide, a non-equal mixture of L and D lactides, a mixture of L, D, and meso-lactides, β-butyrolactone, or 4-(but-3-en-1-yl)oxetan-2-one.

52. An isotactically enriched polylactic acid produced by the method of claim 36.

53. A method of making a complex having the structure of formula (Ia) or its corresponding dimer of formula (Ib): 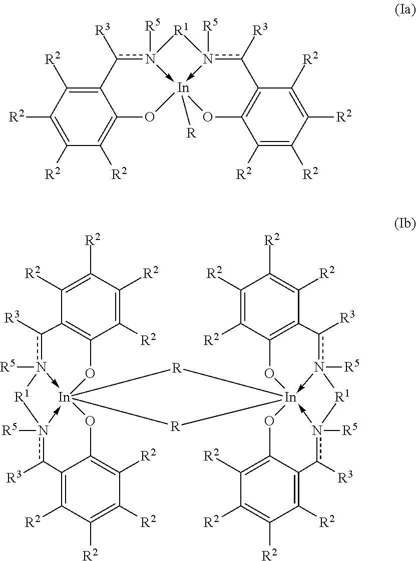
wherein
the dashed line represents an optional double bond;
R¹ is an optionally substituted C₂₋₅ alkylene, 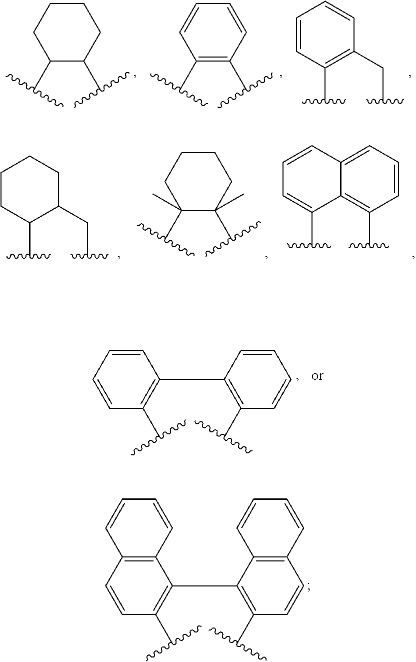
each R² is independently hydrogen, halogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl), optionally substituted aryl or SiR′₃, where each R′ is alkyl or aryl;
each R³ is hydrogen or optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl);
each R is independently OR⁴, where each R⁴ is hydrogen, optionally substituted linear or branched C₁₋₁₈ alkyl (e.g., C₁₋₅ alkyl), such as a fluoro-substituted alkyl, or optionally substituted linear or branched (C₁₋₁₂)alkylcarbonyl (e.g., (C₁₋₅)alkylcarbonyl), such as C(O)CH₂OCH₃; and
each R⁵ is independently hydrogen, optionally substituted linear or branched C₁₋₁₈ alkyl (e.g., C₁₋₁₀ alkyl), optionally substituted cyclic C₃₋₁₈ alkyl (e.g., cyclic C₃₋₁₂ alkyl) or, when there is a C—N double bond, absent,
comprising:
a) reacting a compound of formula (IIa) with a strong base to give a diphenoxide 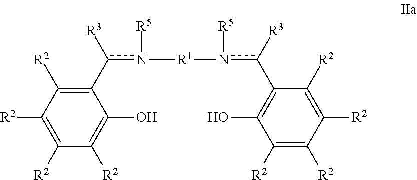
b) complexing the diphenoxide of step a) with an indium salt InX₃ to give an indium complex of formula (IIb), 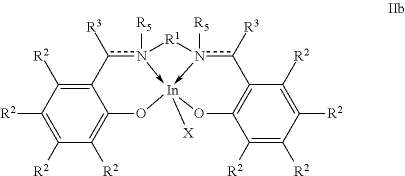
wherein X is an anion, and
c) reacting the indium complex of formula (IIb) with a salt of R⁴OM, wherein M is a metal cation, such as Li⁺, Na⁺ or K⁺, or NR⁶₄⁺, wherein R⁶ is an alkyl.

54. The method of claim 53, wherein the acceptable anion is fluorine, chlorine, bromine, iodine, triflate or an alkoxide.

55. An isotactically enriched polylactic acid produced by the method of claim 48.
